(19) United States
(12) Patent Application Publication
(10) Pub. No.: US 2018/0095711 A1
(43) Pub. Date: Apr. 5, 2018

(54) COMMUNICATION TERMINAL, COMMUNICATION SYSTEM, TRANSMISSION METHOD, AND RECORDING MEDIUM STORING PROGRAM

(71) Applicants: Tomoki KANDA, Kanagawa (JP); Shigeru NAKAMURA, Kanagawa (JP); Yoshinaga KATO, Kanagawa (JP); Ayako WATANABE, Kanagawa (JP)

(72) Inventors: Tomoki KANDA, Kanagawa (JP); Shigeru NAKAMURA, Kanagawa (JP); Yoshinaga KATO, Kanagawa (JP); Ayako WATANABE, Kanagawa (JP)

(21) Appl. No.: 15/663,943

(22) Filed: Jul. 31, 2017

(30) Foreign Application Priority Data
Sep. 30, 2016 (JP) 2016-193251
May 19, 2017 (JP) 2017-099616

(51) Int. Cl. G06F 3/14; G06T 11/60; G06T 11/20

(52) U.S. Cl. CPC G06F 3/1454; G06T 2200/24; G06T 11/203; G06T 11/60

(57) ABSTRACT

A communication terminal, a communication system, a transmission method, and a recording medium storing program. The communication terminal and the transmission method includes controlling a display to display a first superimposed image where a drawn image and a user interface image related to drawing operation are superimposed on a background image, and transmitting image data of a second superimposed image, where the drawn image is superimposed on the background image and the user interface image is excluded from images to be superimposed, to an external communication terminal as image data to be displayed on the display. The communication system includes the communication terminal and the external communication terminal. The recording medium stores a program for causing a computer to execute the transmission method.

### CROSS-REFERENCE TO RELATED APPLICATIONS

This patent application is based on and claims priority pursuant to 35 U.S.C. § 19(a) to Japanese Patent Application Nos. 2016-193251 and 2017-099616, filed on Sep. 30, 2016, and May 19, 2017, respectively, in the Japan Patent Office, the entire disclosures of which are hereby incorporated by reference herein.

### BACKGROUND

### Technical Field

Embodiments of the present disclosure relate to a communication terminal, a communication system, a transmission method, and a recording medium storing program.

### Background Art

With the need for reducing costs or times associated with business trips in recent years, communication systems are widely used, which are capable of carrying out videoconferences among remotely located sites through a communication network such as the Internet or private lines. As communication terminals in a communication system, for example, electronic whiteboards that transmit stroke data such as of a drawn text, or video conference terminals that transmit video data such as of a conference participant are known in the art. In such a communication system as above, as long as a communication terminal on one side is installed with an application that generates a screen image from certain contents of data, even if a communication terminal on the other side is not installed with the above application, the communication terminal on one side can perform rendering on the screen image and transmit it to the communication terminal on the other side such that the screen will be shared among multiple communication terminals.

### SUMMARY

Embodiments of the present disclosure described herein provide a communication terminal, a communication system, a transmission method, and a recording medium storing program. The communication terminal and the transmission method includes controlling a display to display a first superimposed image where a drawn image and a user interface image related to drawing operation are superimposed on a background image, and transmitting image data of a second superimposed image, where the drawn image is superimposed on the background image and the user interface image is excluded from images to be superimposed, to an external communication terminal as image data to be displayed on the display. The communication system includes the communication terminal and the external communication terminal. The recording medium stores a program for causing a computer to execute the transmission method.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 is a diagram illustrating a schematic network configuration of a communication system, according to an embodiment of the present invention.

FIG. 2 is a schematic block diagram illustrating a hardware configuration of an electronic whiteboard, according to an embodiment of the present disclosure.

FIG. 3 is a schematic block diagram illustrating a hardware configuration of a management, system according to an embodiment of the present disclosure.

FIG. 4 is a schematic block diagram illustrating a hardware configuration of a transmission terminal according to an embodiment of the present disclosure.

FIG. 5A and FIG. 5B are schematic block diagrams each illustrating a software configuration of an electronic whiteboard or a transmission terminal, respectively, according to an embodiment of the present disclosure.

FIG. 6 is a functional block diagram of a communication system, according to an embodiment of the present disclosure.

FIG. 7 is a functional block diagram of a drawing controller according to an embodiment of the present disclosure.

FIG. 8 is a sequence diagram illustrating the processes of establishing communication among a plurality of electronic whiteboards, according to an embodiment of the present disclosure.

FIG. 9 is a sequence diagram illustrating the processes of establishing communication between an electronic whiteboard and a transmission terminal, according to an embodiment of the present disclosure.

FIG. 10A and FIG. 10B are data sequence diagrams each illustrating the processes of generating an image, according to an embodiment of the present disclosure.

FIG. 11A and FIG. 11B are diagrams each illustrating a superimposed image, according to an embodiment of the present disclosure.

FIG. 12 is a sequence diagram illustrating the processes of sending the screen image on an electronic whiteboard side to a transmission terminal, according to an embodiment of the present disclosure.

FIG. 13 is a diagram illustrating an example display according to an embodiment of the present disclosure.

FIG. 14A and FIG. 14B are diagrams each illustrating an example display according to an embodiment of the present disclosure.

FIG. 15 is a diagram illustrating a schematic configuration of a communication system, according to a fourth embodiment of the present disclosure.

FIG. 16 is a schematic block diagram illustrating a hardware configuration of a telephone terminal, according to an embodiment of the present disclosure.

FIG. 17A, FIG. 17B, and FIG. 17C are functional block diagrams of an electronic whiteboard, a data server, and a telephone terminal, respectively, according to a fourth embodiment of the present disclosure.

FIG. 18 is a sequence diagram illustrating the processes of downloading the data of a background image by an electronic whiteboard, according to a fourth embodiment of the present disclosure.

FIG. 19 is a diagram illustrating an example display according to an embodiment of the present disclosure.

FIG. 20 is a sequence diagram illustrating the processes of downloading the data of a background image by an electronic whiteboard, according to a fifth embodiment of the present disclosure.

FIG. 21 is a diagram illustrating stroke arrangement data according to an embodiment of the present disclosure.

FIG. 22 is a diagram illustrating an example data structure of the coordinate arrangement data, according to an embodiment of the present disclosure.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific-integrated-circuits (ASICs), field programmable gate arrays (FPGAs), computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

In the following description, a first embodiment of the present invention is described with reference to the drawings.

<<Schematic Configuration of Communication System>>

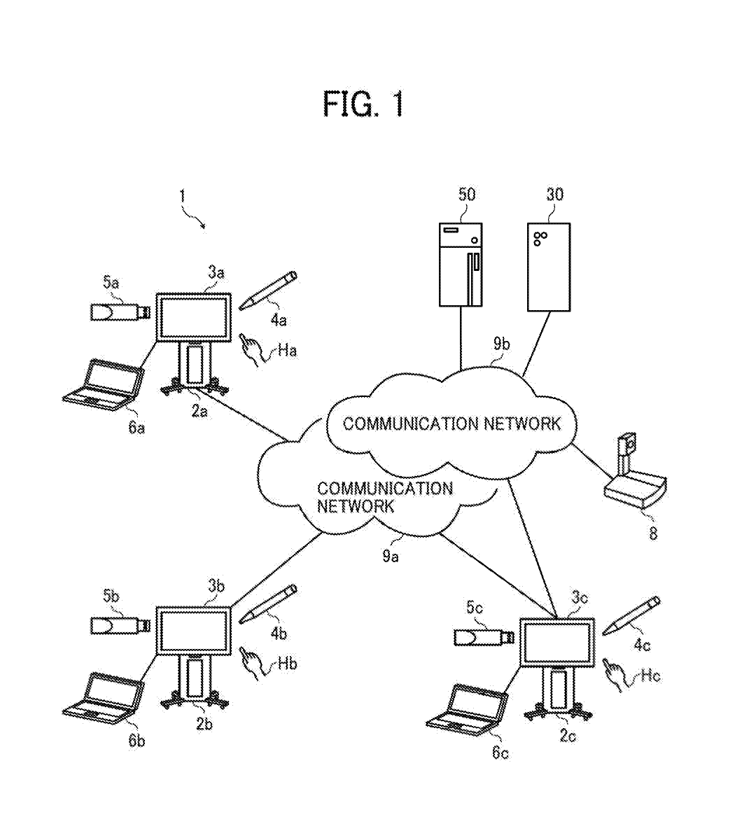

Firstly, a communication system 1 is described with reference to FIG. 1.

FIG. 1 is a diagram illustrating a schematic configuration of the communication system 1, according to an embodiment of the present disclosure.

The communication system 1 according to the present embodiment includes a plurality of electronic whiteboards 2a, 2b, and 2c, a transmission terminal 8, a relay device 30, and a management system 50.

The electronic whiteboards 2a, 2b, and 2c are connected to each other and can communicate with each other via a communication network 9a. Moreover, the electronic whiteboards 2a, 2b, and 2c are provided with displays 3a, 3b, and 3c, respectively.

The electronic whiteboards 2a, 2b, and 2c can control the displays 3a, 3b, and 3c to display images that are drawn by the events caused by electronic styluses 4a, 4b, and 4c (i.e., the touches on the displays 3a, 3b, and 3c by the tip or bottom of the electronic styluses 4a, 4b, and 4c). Note also that the electronic whiteboards 2a, 2b, and 2c can control the displays 3a, 3b, and 3c to modify the images being displayed on the displays 3a, 3b, and 3c according to the events caused not only by the electronic styluses 4a, 4b, and 4c but also by user's hands Ha, Hb, and He, or the like (i.e., gestures such as for zooming in, zooming out, and flipping pages). Hereinafter, any one of the electronic whiteboards 2a, 2b, and 2c may be referred to simply as the electronic whiteboard 2, and any one of the displays 3a, 3b, and 3c may be referred to simply as the display 3. Likewise, any one of the electronic styluses 4a, 4b, and 4c may be referred to simply as the electronic stylus 4, and any one of the user's hands Ha. Hb, and He may be referred to simply as the hand H.

To the electronic whiteboards 2a, 2b, and 2c, universal serial bus (USB) memories 5a, 5b, and 5c may be connected. The electronic whiteboards 2a, 2b, and 2c can read electronic files such as portable document format (PDF) files from the USB memories 5a, 5b, and 5c, or can store such electronic files in the USB memories 5a, 5b, and 5c. Moreover, laptop personal computers (PCs) 6a, 6b, and 6c are connected to the electronic whiteboards 2a, 2b, and 2c, respectively, through a cable that allows communication under the standard such as DisplayPort, digital visual interface (DVI), high-definition multimedia interface (HDMI), registered trademark), and video graphics array (VGA). Note also that any one of the USB memories 5a, 5b, and 5c may be referred to simply as the USB memory 5, and any one of the laptop PCs 6a, 6b, and 6c may be referred to simply as the laptop PC 6.

Due to the configuration as described above, the stroke data of a stroke that is drawn on the display 3 of the electronic whiteboard 2 at one site is transmitted to the electronic whiteboard 2 at another site through the communication network 9a, and the stroke data can also be displayed on the display 3 at the other site. In a similar manner, the stroke data that is drawn on the display 3 of the electronic whiteboard 2 at the other site is transmitted to the electronic whiteboard 2 at the one site through the communication network 9a, and the stroke data can be displayed on the display 3 of the electronic whiteboard 2 at the one site. As described above, drawing images can be shared among remote sites, such that the communication system 1 with the multiple electronic whiteboards 2 can facilitate a video conference.

Note also that any desired external communication terminal other than the electronic whiteboard 2 as above may additionally be connected to the communication network 9a to share stroke data with the electronic whiteboard 2. Such any desired external communication terminal includes a personal computer (PC) with a stroke sharing function, a video conference terminal, a tablet personal computer (PC), a smartphone, digital signage, a telestrator that is often used, for example, in sports and weather broadcasts, or a computer including, for example, an image processing device such as a remote image (video) diagnostic device, a mobile information terminal, a digital video camera, a digital camera, and a terminal such as a game machine capable of providing image frames

The transmission terminal 8 is an example of a communication terminal for video conference capable of transmitting video data and audio data. The transmission terminal 8 may be replaced with a tablet personal computer (PC), a smartphone, digital signage, a telestrator, an image processing device, a mobile information terminal, a digital video camera, a digital camera, and a communication terminal capable of providing image frames such as a game machine. The electronic whiteboard 2c out of the electronic whiteboards 2a, 2b, and 2c is installed with a video conference application, and is capable of transmitting not only stroke data but also video data and audio data. Due to this configuration, the electronic whiteboard 2c and the transmission terminal 8 can exchange the video data and audio data for video conference through the communication network 9b.

The relay device 30 relays the video data and audio data transmitted by one of the electronic whiteboard 2c and the transmission terminal 8 to the other one of the electronic whiteboard 2c and the transmission terminal 8.

The management system 50 centrally manages, for example, the communication status between the electronic whiteboard 2c and the transmission terminal 8.

According to the present embodiment, the communication network 9a is an intranet, and the communication network 9b is the Internet. However, the communication networks 9a and 9b are not limited to the above configuration, and may be any desired communication network selected from the Internet, the local area network (LAN), the intranet, the mobile phone network, or the like. Alternatively, the communication networks 9a and 9b may be the same network. For example, both the communication networks 9a and 9b may be the Internet.

<Hardware Configuration of Electronic Whiteboard>

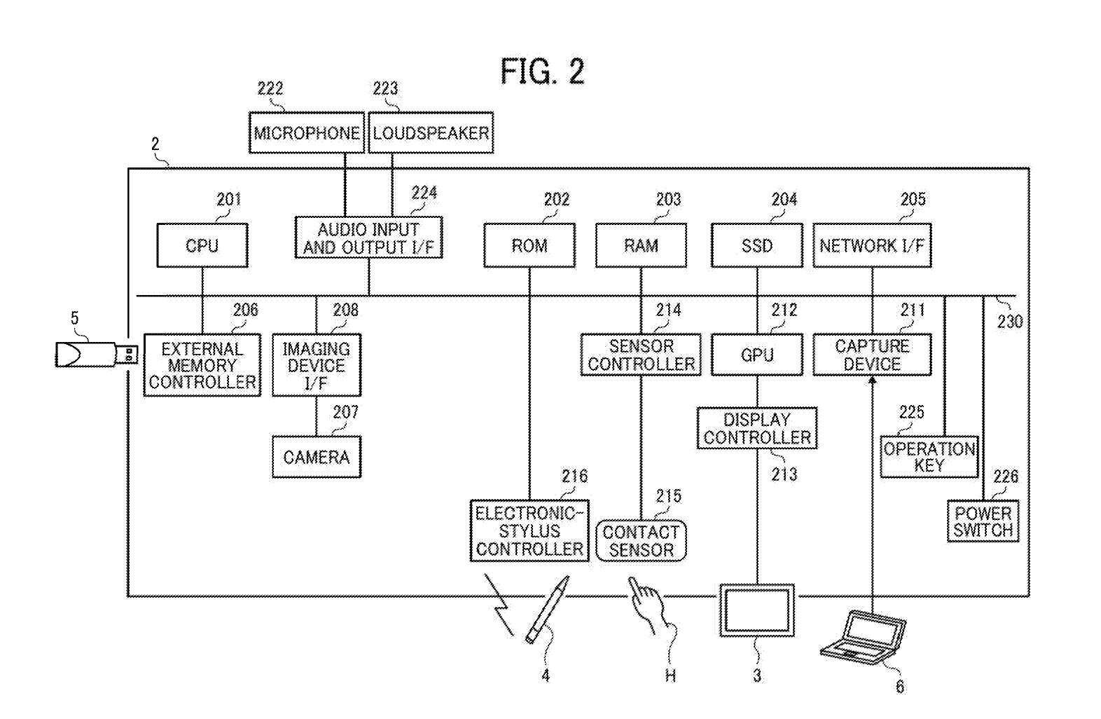

The hardware configuration of the electronic whiteboard 2 according to the present embodiment is described with reference to FIG. 2.

FIG. 2 is a schematic block diagram illustrating a hardware configuration of the electronic whiteboard 2 according to the present embodiment.

As illustrated in FIG. 2, the electronic whiteboard 2 includes, for example, a central processing unit (CPU) 201 that controls the overall operation of the electronic whiteboard 2, a read only memory (ROM) 202 that stores a control program used for controlling the CPU 201 such as an initial program loader (IPL), a random access memory (RAM) 203 that is used as a work area for the CPU 201, a solid state disk (SSD) 204 that stores various data such as a control program for the electronic whiteboard 2, a network interface (I/F) 205 that controls the communication with an external device through the communication network 9, and an external memory controller 206 that controls the communication with an external device such as a universal serial bus (USB) memory 5. Further, the electronic whiteboard 2 includes, for example, a camera 207 that captures a target object under the control of the CPU 201, an imaging device interface (I/F) 208 that controls the operation of the camera 207, a capture device 211 that controls the display of a laptop personal computer (PC) 6 to display the video data as a still image or moving images, a graphics processing unit (GPU) 212 specializing in processing graphics, and a display controller 213 that controls the visual display to output the image generated by the GPU 212 to the display 3. Further, the electronic whiteboard 2 includes, for example, a sensor controller 214 that controls operation of the contact sensor 215, and a contact sensor 215 that detects a touch onto the display 3, which is made by, for example, an electronic stylus 4 and a user's hand H. The contact sensor 215 according to the present embodiment senses a touch input to a specific coordinate on the display 3 using the infrared blocking system. More specifically, the display 3 is provided with two light receivers and light emitters disposed on both upper ends of the display 3, and a reflector frame disposed on the periphery of the display 3. The light receivers and light emitters emit a plurality of infrared rays in parallel to a touch panel of the display 3. The light receivers and light emitters receive lights passing in the direction that is the same as that of an optical path of the emitted infrared rays, which are reflected by the reflector frame. By so doing, a touch input to specific coordinates is sensed. The contact sensor 215 outputs to the sensor controller 214 the identification (ID) of the infrared light rays that are emitted from the two light receivers and light emitters and then are blocked by an object such as the hand H, and the sensor controller 214 specifies the coordinates of the position touched by the object. Note also that all sorts of ID as described below are an example of identification information.

In the present embodiment, the contact sensor 215 uses the infrared blocking system. However, no limitation is intended therein, and the contact sensor 215 may use various types of detectors such as a capacitive touch panel that detects changes in capacitance to specify a touched position, a resistive touch panel that senses changes in voltage between two facing resistive membranes to specify a touched position, and an electromagnetic induction type touch panel that detects electromagnetic induction caused when an object touches a display to specify a touched position. Alternatively, the contact sensor 215 may identify the contact position using the camera 207.

The electronic whiteboard 2 is provided with an electronic stylus controller 216. The electronic stylus controller 216 communicates with the electronic stylus 4 to detect a touch by the tip or bottom of the electronic stylus 4 to the display 3. In addition or in alternative to detecting a touch by the tip or bottom of the electronic stylus 4, the electronic stylus controller 216 may also detect a touch by another part of the electronic stylus 4, such as a part held by a hand.

Further, the electronic whiteboard 2 includes, for example, an audio input and output interface (I/F) 224 that controls the input and output of an audio signal between an external microphone 222 and an external loudspeaker 223 under the control of the CPU 101, an operation key 225 that accepts user's operation, and a power switch 226 that turns on or turns off the power of the electronic whiteboard 2. Note also that any of the microphone 222 and the loudspeaker 223 may be built into the electronic whiteboard 2.

Further, the electronic whiteboard 2 includes, for example, a bus line 230, such as an address bus or a data bus, which electrically connects the elements illustrated in FIG. 2 to one another.

The control program for the electronic whiteboard 2 may be stored on a computer-readable recording medium such as a CD-ROM for distribution, or stored on a server on any desired network to be downloaded.

<Hardware Configuration of Management System>

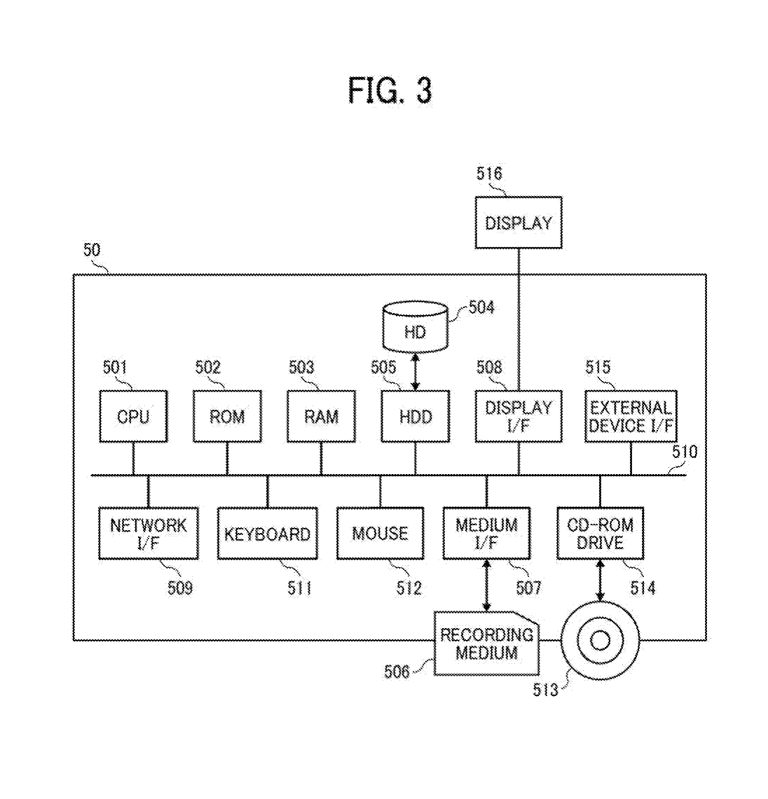

The hardware configuration of the management system 50 according to the present embodiment is described with reference to FIG. 3.

FIG. 3 is a schematic block diagram illustrating a hardware configuration of the management system 50 according to the present embodiment.

The management system 50 according to the present embodiment includes a CPU 501 that controls the entire operation of the management system 50, a ROM 502 storing a transmission control program, a RAM 503 that is used as a work area for the CPU 501, a hard disk (HD) 504 storing various kinds of data, a hard disk drive (HDD) 505 that controls reading or writing of various kinds of data to or from the HI) 504 under control of the CPU 501, and a medium interface (I/F) 507 that controls reading or writing of data to or from a recording medium 506 such as a flash memory. Moreover, the management system 50 according to the present embodiment includes a display interface (I/F) 508 that controls the display 516 to display various kinds of information such as a cursor, a menu, a window, a character, and an image, a network interface (I/F) 509 that transmits data using the communication network 9, a keyboard 511 that is provided with a plurality of keys for allowing a user to input, for example, characters, numerical values, and various kinds of instructions, a mouse 512 that is one example of pointing device for allowing a user to select or execute various kinds of instructions, select a target to be processed, or to move a mouse cursor being displayed. Further, the management system 50 according to the present embodiment includes a compact disc read only memory (CD-ROM) drive 514 that reads or writes various kinds of data to and from a CD-ROM 513, which is one example of removable recording medium, an external device interface (I/F) 515 that exchanges data with an external device, and a bus line 510, such as an address bus or a data bus, which electrically connects the elements illustrated in FIG. 2 to one another.

The above transmission control program is in an installable or executable file format, and may be recorded on a computer-readable recording medium such as the recording medium 506 and the CD-ROM 513 for distribution. The above transmission control program may be stored on the HD 504.

The hardware configuration of the relay device 30 is equivalent to that of the management system 50, and thus its description is omitted.

<Hardware Configuration of Transmission Terminal>

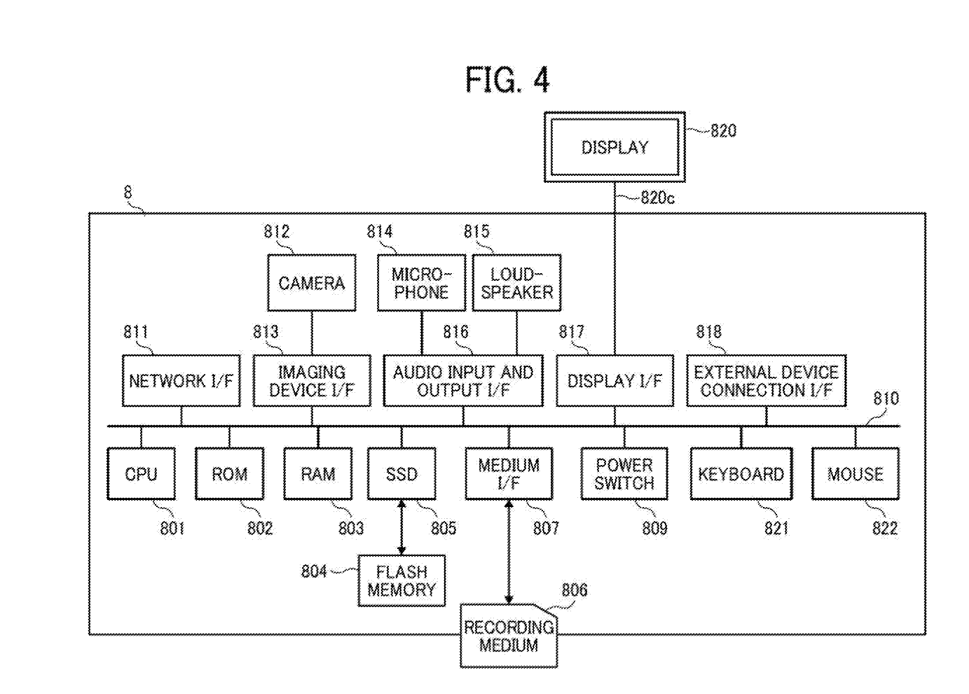

FIG. 4 is a schematic block diagram illustrating a hardware configuration of the transmission terminal 8 operating as a video conference terminal, according to the present embodiment.

The transmission terminal 8 includes, for example, a central processing unit (CPU) 801, a read only memory (ROM) 802, a random access memory (RAM) 803, a flash memory 804, a solid state drive (SSD) 805, a medium interface (I/F) 807, a power switch 809, a bus line 810, a network interface (I/F) 811, a camera 812, an imaging device interface (I/F) 813, a microphone 814, a loudspeaker 815, an audio input and output interface (I/F) 816, a display interface (I/F) 817, an external device connection interface (I/F) 818, a keyboard 821, and a mouse 822. The CPU 801 controls the overall operation of the transmission terminal 8. The ROM 802 stores a control program such as an initial program loader (IPL) used for operating the CPU 801. The RAM 803 is used as a work area for the CPU 801. The flash memory 804 stores various kinds of data such as a communication control program, display data, and audio data. The SSD 805 controls reading or writing of various kinds of data to or from the flash memory 804 under control of the CPU 801. As an alternative to the SSD, a hard disk drive (HDD) may be used. The medium interface 807 controls reading or writing of data to or from a recording medium 806 such as a flash memory.

The network interface 811 controls data communication with an external device through the communication network 9b. The camera 812 is an example of a built-in imaging device that captures an object under the control of the CPU 801 to obtain display data. The imaging device interface 813 is a circuit that controls operation of the camera 812. The microphone 814 is an example of a built-in sound collector capable of receiving audio data. The audio input and output interface 816 is a circuit for controlling an input and output of an audio signal between the microphone 814 and the loudspeaker 815, under control of the CPU 801. The display interface 817 is a circuit for transmitting display data to the external display 820 under control of the CPU 801. The external device connection interface 818 is an interface circuit that connects the transmission terminal 8 to various kinds of external devices. The keyboard 821 is one example of input device provided with a plurality of keys for allowing an user to input characters, numerical values, or various kinds of instructions. The mouse 822 is one example of pointing device for allowing a user to select or execute various kinds of instructions, select a target to be processed, or to move a mouse cursor being displayed.

The bus line 810 is, for example, an address bus or a data bus, which electrically connects a plurality of elements as illustrated in FIG. 4 such as the CPU 801.

The display 820 is an example of a display unit composed of a liquid crystal or organic electroluminescence (EL) display that displays, for example, an image of an object and an operation icon. Moreover, the display 820 is connected to the display interface 817 by a cable 820c. The cable 820c may be an analog RGB (red, green, blue) (video graphic array (VGA)) signal cable, a component video cable, a high-definition multimedia interface (HDMI, registered trademark) signal cable, or a digital video interactive (DVI) signal cable.

The camera 812 includes a lens, and a solid-state image sensing device that converts an image or moving images (video) of an object into electronic data through photoelectric conversion. As the solid-state image sensing device, for example, a complementary metal oxide semiconductor (CMOS) or a charge-coupled device (CCD) is used. The external device connection interface 818 is capable of connecting an external device such as an external camera, an external microphone, or an external loudspeaker thereto through a universal serial bus (USB) cable or the like.

The recording medium 806 is removable from the transmission terminal 8. The flash memory 804 may be replaced with any nonvolatile memory such as an electrically erasable and programmable read only memory (EEPROM) that reads or writes data under control of the CPU 801.

<Software Configuration of Communication Terminal>

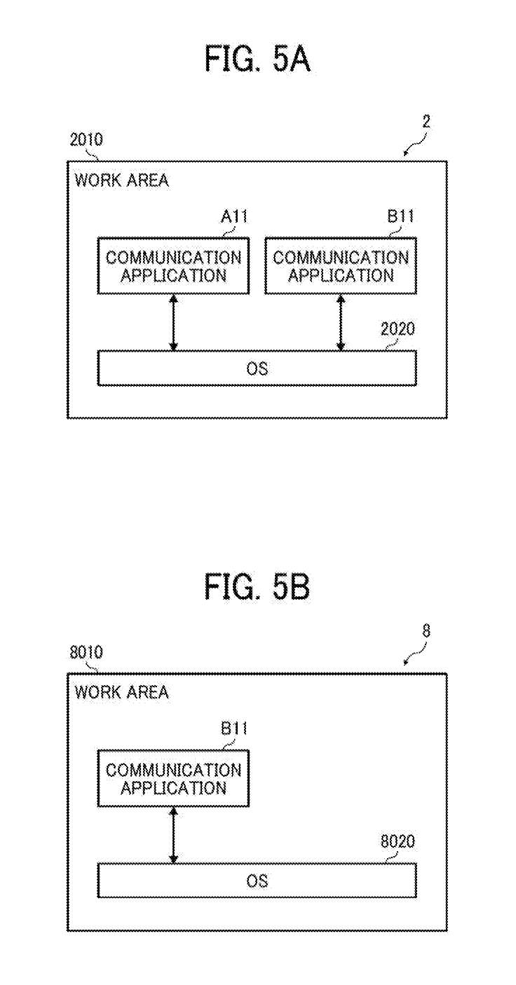

FIG. 5A is a schematic block diagram illustrating a software configuration of the electronic whiteboard 2, according to the present embodiment.

As illustrated in FIG. 5A, the electronic whiteboard 2 is installed with an operating system (OS) 2020, a first communication application A11, and a second communication application B11, each of which operates on a work area 2010 of the RAM 203.

The OS 2020 is basic software that controls entire operation of the electronic whiteboard 2 through providing basic functions. The communication application A11 and B11 each enable the electronic whiteboard 2 to communicate with another electronic whiteboard (or communication terminal), using different communication protocols. The communication application A11 is a client application that provides the electronic whiteboard 2 with a communication control function of controlling transmission of stroke data to another communication terminal, and an image processing function of outputting the stroke data as an image. The communication application B11 is a client application that provides the electronic whiteboard 2 with a communication control function of sending and receiving the video data or audio data of a conference or the like to or from another communication terminal, an image processing function of inputting and outputting the video data, and an audio processing function of inputting and outputting the audio data.

The OS 2020 and the communication application A11 are installed onto the electronic whiteboards 2a, 2b, and 2c before shipment. The communication application B11 may be installed onto the electronic whiteboard 2 as desired after shipment. In the following description, it is assumed that the electronic whiteboard 2c is installed with the communication application B11, but the electronic whiteboards 2a and 2b are not installed with the communication application B11.

FIG. 5B is a schematic block diagram illustrating a software configuration of the transmission terminal 8, according to the present embodiment.

As illustrated in FIG. 5B, the OS 8020 and the third communication application B11 are deployed and operate on a work area 8010 of the RAM 803.

The OS 8020 is basic software that controls the entire operation of the transmission terminal 8 through providing basic functions. The communication application B11 provides the transmission terminal 8 with a communication control function of sending and receiving video data of a conference or the like to or from another external communication terminal, and an image processing function of outputting the video data as an image.

The OS 8020 and the communication application B11 are installed onto the transmission terminal 8 before or after shipment.

<<Functional Configuration of Embodiment>>

Next, a functional configuration of the communication system 1 according to the present embodiment is described.

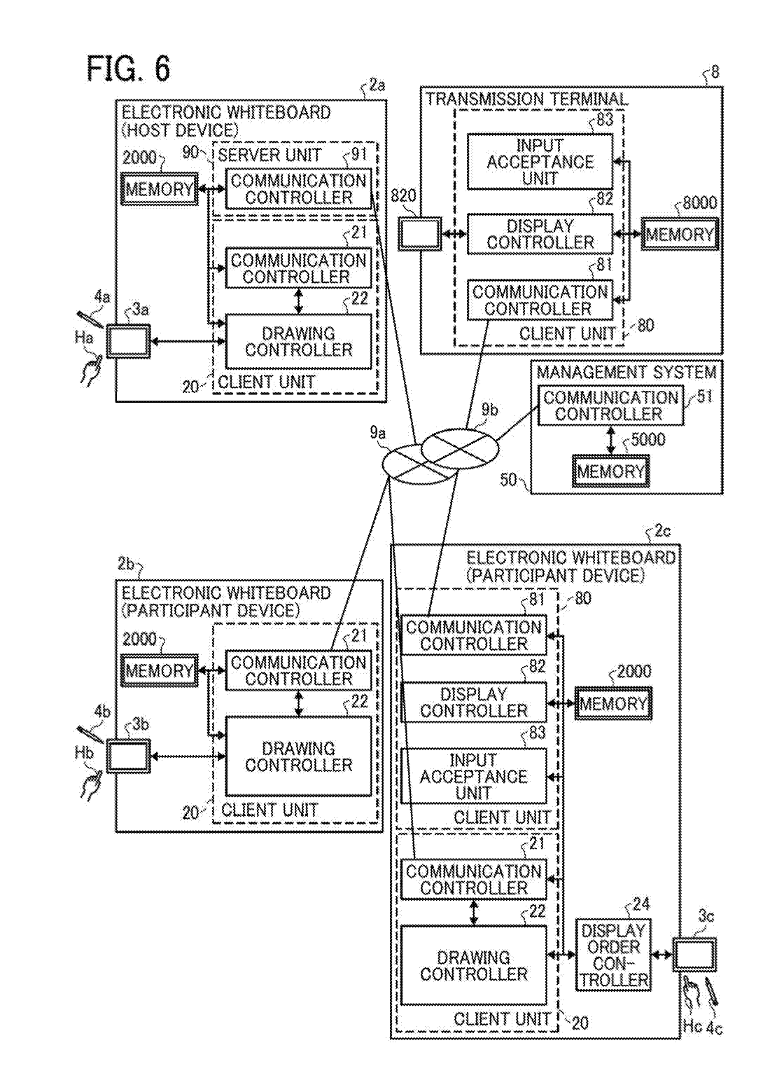

FIG. 6 is a schematic block diagram illustrating a functional configuration of the electronic whiteboards 2, the transmission terminal 8, and the management system 50 in the communication system 1, according to the present embodiment.

The electronic whiteboard 2 is provided with the hardware components as illustrated in FIG. 2 which operate in cooperation with the control programs, thereby implementing the functional configuration as illustrated in FIG. 6. Moreover, the electronic whiteboard 2 includes a memory 2000 implemented by the SSD 204. The transmission terminal 8 is provided with the hardware components as illustrated in FIG. 4 that operate in cooperation with the control programs, thereby implementing the functional configuration as illustrated in FIG. 6. Moreover, the transmission terminal 8 includes a memory 8000 implemented by the SSD 805.

The electronic whiteboard 2 may serve as a “host device” that firstly requests to start communication to share images (remote sharing), or may serve as a “participant device” that later participates in the communication (remote sharing) already started by the host device. In broad outline, the electronic whiteboard 2 consists of a client unit 20 and a server unit 90. The client unit 20 and the server unit 90 are functions implemented by one electronic whiteboard 2, with activation of the communication application A11. Alternatively, the electronic whiteboard 2 may only include the client unit 20, and a device such as a distribution controller other than the electronic whiteboard 2 may implement the server unit 90.

When the electronic whiteboard 2 serves as a host device, both the client unit 20 and the server unit 90 are implemented by the electronic whiteboard 2. Moreover, when the electronic whiteboard 2 serves as a participant device, only the client unit 20 is implemented by the electronic whiteboard 2, and the server unit 90 is not implemented. In other words, when the electronic whiteboard 2a serves as a host device and the electronic whiteboards 2b and 2c serve as participant devices, the client unit 20 of the electronic whiteboard 2a communicates with the client unit 20 of each of the other electronic whiteboards 2b and 2c, through the server unit 90 implemented in the same electronic whiteboard 2a. By contrast, the client unit 20 of each one of the electronic whiteboards 2b and 2c communicates with the client unit 20 of each of the other electronic whiteboard 2a, 2b, or 2c, through the server unit 90 implemented in the electronic whiteboard 2a.

<Functional Configuration of Client Unit 20>

As the communication application A11 is started in the electronic whiteboard 2, the client unit 20 starts operating. The client unit 20 includes a communication controller 21 and a drawing controller 22.

The communication controller 21 is implemented by the network interface 205 or the instructions from the CPU 201, and controls the communication performed with another electronic whiteboard 2 or the communication performed with the server unit 90 or the like of the same electronic whiteboard 2.

The drawing controller 22 is implemented by the instructions from the CPU 201, and performs image processing based on the stroke data generated in response to operation made on the display 3, or based on various kinds of data obtained from any desired device. Examples of such a device include, but not limited to, the USB memory 5, the laptop PC 6, the communication controller 21, and the memory 2000. The drawing controller 22 generates an image layer based on the processed image data, and controls output of a combined image where a plurality of image layers are superimposed on top of one another.

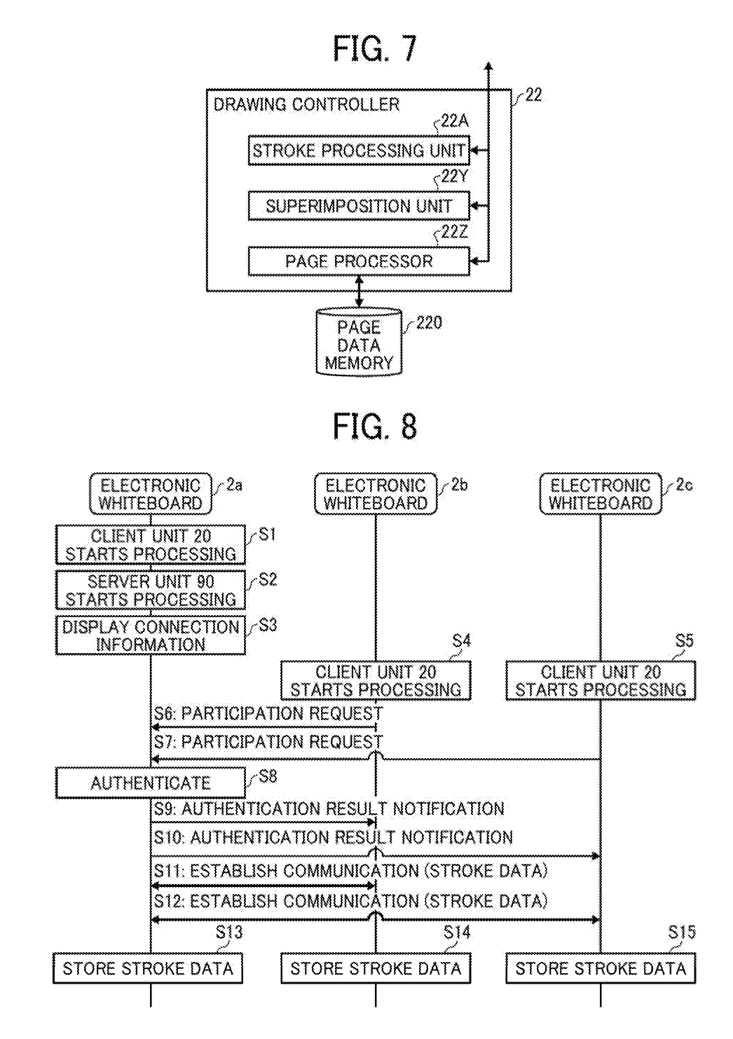

FIG. 7 is a functional block diagram of the drawing controller 22, according to the present embodiment.

The drawing controller 22 includes a stroke processing unit 22A, a superimposition unit 22Y, and a page processor 22Z.

The stroke processing unit 22A may be implemented by the instructions from the CPU 201, and generates stroke data that reflects the user's drawing on the display 3 with the electronic stylus 4 or the user's hand H.

The superimposition unit 22Y may be implemented by the instructions from the CPU 201, and generates a plurality of image layers based on each type of data and superimposes those image layers on top of one another.

The page processor 22Z associates a plurality of items of display data such as of stroke data with each other as one page of data, and stores the associated items of display data in a page data memory 220 of the memory 2000.

The page data memory 220 is a memory area of the memory 2000, and stores page data as depicted in Table 1 given below. Table 1 is a diagram illustrating an example data structure of the page data. The page data includes one-page data to be displayed on the display 3, which includes stroke arrangement data (items of stroke data for one character, etc.) and medium data.

TABLE 1

| | | | STROKE | |
|---|---|---|---|---|
| PAGE | | | ARRANGE- | |
| DATA | | | MENT | MEDIUM |
| ID | START TIME | END TIME | DATA ID | DATA ID |
| p001 | 20150522152034 | 20150522152402 | st001 | m001 |
| p002 | 20150522152415 | 20150522152825 | st002 | m002 |
| p003 | 20150522153345 | 20150522154033 | st003 | m003 |
| . . . | . . . | . . . | . . . | . . . |

In the page data, page data ID by which any desired one page is identified, the start time at which the display of that page is started, the end time when rewriting of page is no longer performed, for example, by stroke and gesture, stroke arrangement data ID that identifies the stroke arrangement data caused by the stroke of the electronic stylus 4 or the user's hand H, and medium data ID that identifies the medium data are stored in association with each other. The stroke arrangement data is used to display a set of stroke images on the display 3. The medium data is used to display another image overlapping with the stroke image on the display 3.

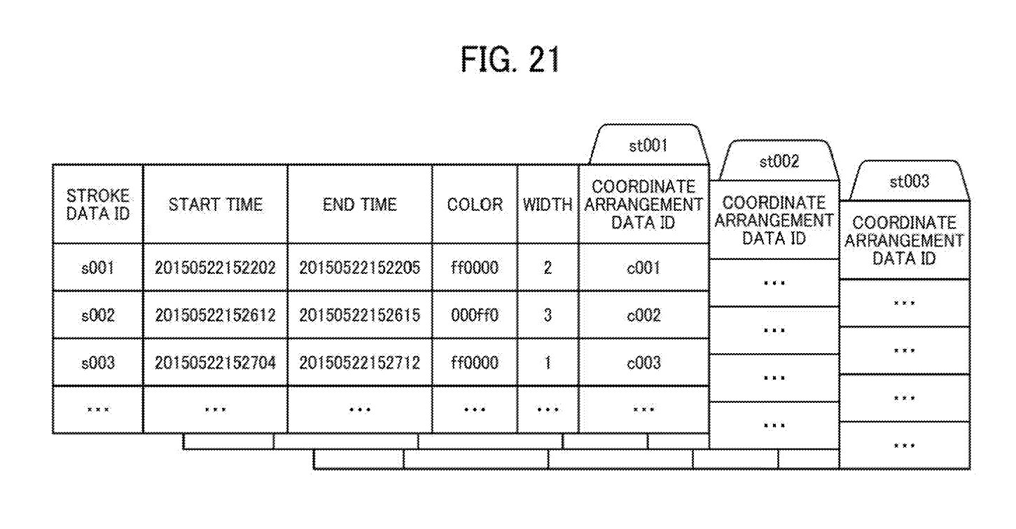

The stroke arrangement data includes information in detail as depicted in FIG. 21.

FIG. 21 is a diagram illustrating stroke arrangement data according to the present embodiment.

As illustrated in FIG. 21, one stroke arrangement data includes a plurality of items of stroke data. Further, one item of stroke data indicates stroke data ID that identifies that stroke data, the start time at which the writing of one item of stroke starts, the end time at which the writing of one item of stroke ends, the color of the stroke, the width of the stroke, and the coordinate arrangement data ID that identifies the arrangement of way points of the stroke. For example, when the user draws an alphabet “S” with the electronic stylus 4 with a single stroke, one item of stroke data ID is assigned to the single character of alphabet “S”. However, when the user draws an alphabet “T” with the electronic stylus 4 with two strokes, two items of stroke data ID are assigned to the single character of alphabet “T”.

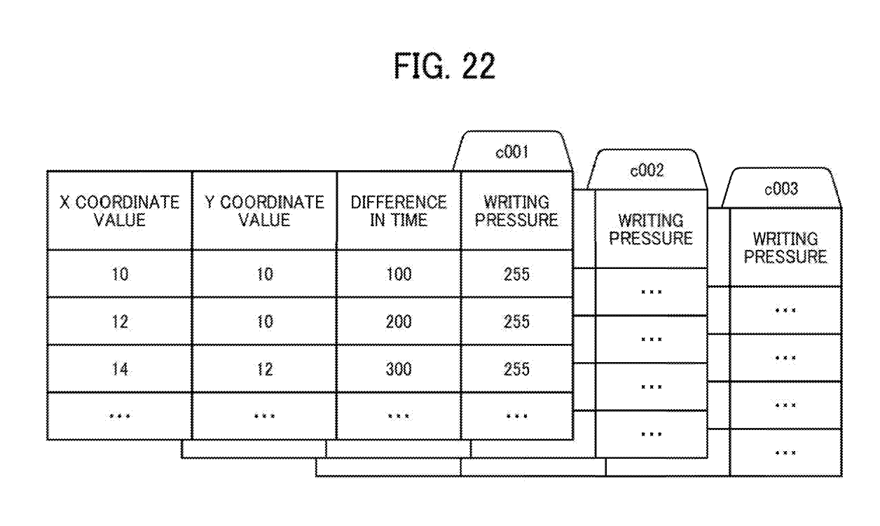

Further, the coordinate arrangement data includes information in detail as depicted in FIG. 22.

FIG. 22 is a diagram illustrating an example data structure of the coordinate arrangement data, according to the present embodiment.

The coordinate arrangement data indicates several items of information including a point on the display 3 (X coordinate value, Y coordinate value), the difference in time (millisecond (ms)) when passing through this point since the start time of the stroke, and the writing pressure of the electronic stylus 4 on that point. In other words, a collection of several points depicted in FIG. 22 is indicated by one item of coordinate arrangement data as depicted in FIG. 21. For example, when the user draws an alphabet “S” using the electronic stylus 4 with a single stroke, a plurality of way points are passed through to complete the drawing of “S”. Due to this configuration, the coordinate arrangement data indicates those multiple way points in the stroke drawing.

The medium data of the page data in Table 1 includes more detailed information as depicted in Table 2. Table 2 depicts an example data structure of medium data. In the medium data, the medium data ID included in the page data depicted in Table 1, the type of data of the medium data, the time at which the medium data is stored, the position (X coordinate value, Y coordinate value) of the image to be displayed on the display 3 according to the medium data, and the size (width, height) of the image, as well as the data indicating the contents of the medium data are associated with each other. Among these items of data, the position of the image to be displayed on the display 3 according to the medium data indicates the upper-left corner of the image that is displayed according to the medium data assuming that the coordinates of upper-left corner of the display 3 is (X coordinate value, Y coordinate value)=(0, 0).

TABLE 2

| MEDIUM | TYPE OF | RECORDED | X COORDINATE | Y COORDINATE | | | |
|---|---|---|---|---|---|---|---|
| DATA ID | DATA | TIME | VALUE | VALUE | WIDTH | HEIGHT | DATA |
| m001 | image | 20150522152632 | 0 | 0 | 1920 | 1080 | abc.jpg |
| m002 | image | 20150522153002 | 277 | 156 | 1366 | 768 | bcd.jpg |
| m003 | image | 20150522154421 | 277 | 156 | 1366 | 768 | cde.jpg |
| . . . | . . . | . . . | . . . | . . . | . . . | . . . | . . . |

<Functional Configuration of Server Unit 90>

The server unit 90 includes a communication controller 91.

The communication controller 91 is implemented by the instructions from the CPU 201, and controls communication, through the communication network 9a, between the communication controller 21 in the client unit 20 of the same electronic whiteboard 2 and the communication controller 21 in the client unit 20 of another one of the electronic whiteboards 2.

<Functional Configuration of Client Unit 80>

As the communication application B11 is started in the electronic whiteboard 2 or the transmission terminal 8, the client unit 80 starts operating. The client unit 80 includes a communication controller 81, a display controller 82, and an input acceptance unit 83.

The communication controller 81 may be implemented by the instructions from the CPU 201 or the CPU 801 or the network interface 205 or the network interface 811, and controls communication with another communication terminal or the like.

The display controller 82 may be implemented by the instructions from the CPU 201 or the CPU 801, and performs image processing based on data obtained from the memory 2000, the memory 8000, or the like, and controls output of processed image data.

The input acceptance unit 83 may be implemented by the instructions from the CPU 201 or the CPU 801, and receives various kinds of operation or input made by a user.

<Display Order Controller>

The electronic whiteboard 2c further includes a display order controller 24. The display order controller 24 starts operating as the OS 2020 is started in the electronic whiteboard 2c.

The display order controller 24 may be implemented by the instructions from the CPU 201, and activates one of the images generated by the client units 20 and 80 and deactivates the other one of the images. Due to this configuration, the display order of these images is controlled. More specifically, the processes of activating one of the images consist of the processes of displaying that image to the front compared with the other images, and the processes of deactivating one of the images consist of the processes of displaying the other images to the front compared with the deactivated image.

<Functional Configuration of Management System 50>

The management system 50 is provided with the hardware components as illustrated in FIG. 3 that operate in cooperation with control programs, thereby implementing each functional configuration as illustrated in FIG. 6. The management system 50 also includes a memory 5000 that is implemented by the HD 504 illustrated in FIG. 3.

The communication controller 51 of the management system 50 may be implemented by the instructions from the CPU 501, and control communication with the electronic whiteboard 2 or the transmission terminal 8 through the communication network 9b.

<<Processes>>

Next, the processes according to the present embodiment are described.

<Establishment of Communication Among Electronic Whiteboards>

With reference to FIG. 8, the processes of establishing communication among the electronic whiteboards 2a, 2b, and 2c, using the communication application A11, are described.

FIG. 8 is a sequence diagram illustrating the processes of establishing communication among a plurality of electronic whiteboards, according to the present embodiment.

Once the power switch 226 of the electronic whiteboard 2a is turned on, the communication application A11 starts operating, and the client unit 20 of the electronic whiteboard 2a starts processing (step S1). Then, once a request to hold a conference is accepted by operation made on the display 3a, the communication controller 21 of the client unit 20 sends instructions to start the processing of the server unit 90 to the communication controller 91 in the server unit 90 of the same electronic whiteboard 2a. Due to this configuration, not only the client unit 20 but also the server unit 90 of the electronic whiteboard 2a starts various kinds of processing (step S2).

The communication controller 91 of the electronic whiteboard 2a generates connection information to establish a connection with the electronic whiteboard 2a, and controls the display 3a to display the generated connection information (step S3). Such connection information includes the IP address of the host device and a pass code generated for the present remote sharing, and the pass code is stored in the memory 2000. Moreover, a user of the electronic whiteboard 2a notifies the users of the electronic whiteboards 2b and 2c of the connection data by means of, for example, telephone or electronic mail.

Next, once the power switch 226 of each of the electronic whiteboards 2b and 2c is turned on, the communication application A11 starts operating in the electronic whiteboards 2b and 2c, and the client unit 20 of each of the electronic whiteboards 2b and 2c starts processing (steps S4 and S5). Once input of connection information is accepted by operation made on the displays 3b and 3c of the electronic whiteboards 2b and 2c, the communication controller 21 in the client unit 20 of each of the electronic whiteboards 2b and 2b transmits a participation request including a pass code to the communication controller 91 in the server unit 90 of the electronic whiteboard 2a, based on the IP address included in the connection information, through the communication network 9a (steps S6 and S7). The communication controller 91 of the electronic whiteboard 2a receives the participation requests including the pass code from each of the electronic whiteboards 2b and 2c.

Next, the communication controller 91 determines whether or not to authenticate each one of the electronic whiteboards 2b and 2c using the pass codes received from the electronic whiteboards 2b and 2c with reference to the pass codes stored in the memory 2000 (step S8). Then, the communication controller 91 notifies each of the client units 20 of the electronic whiteboard 2b and 2c of the authentication result (steps S9 and S10). When the electronic whiteboards 2b and 2c are determined to be an authorized electronic whiteboard in the authentication of the step S8, the electronic whiteboard 2a that serves as the host device establishes a communication for remote sharing with the electronic whiteboard 2b and electronic whiteboard 2c each of which serves as a participant device (steps S11 and S12). In the description of the present embodiment, it is assumed that contents of data exchanged among the electronic whiteboards 2a, 2b, and 2c include stroke data.

When a user draws a stroke image on one of the electronic whiteboards 2a, 2b, and 2c using the electronic stylus 4a, 4b, or 4c, the stroke processing unit 22A of the corresponding one of the electronic whiteboards 2a, 2b, and 2c generates the stroke data of the drawn stroke image based on the coordinates of the contact portion between the electronic styluses 4a, 4b, or 4c and the displays 3a, 3b, or 3c. The communication controller 21 of the relevant one of the electronic whiteboards 2a, 2b, and 2c sends the generated stroke data to the communication controller 91 of the electronic whiteboard 2 that serves as the host device.

As the stroked data is received from the electronic whiteboards 2a, 2b, and 2c, the communication controller 91 of the electronic whiteboard 2a transmits the received stroke data to the client units 20 of the electronic whiteboards 2a, 2b, and 2c. The communication controllers 21 in the electronic whiteboards 2a, 2b, and 2c then receive the transmitted stroke data. The page processors 22Z of the electronic whiteboards 2a, 2b, and 2c controls the page data memory 220 to store the newly received stroke data in an added manner without overwriting the previously stored stroke data (steps S13, S14, and S15). Due to this configuration, the communication among the electronic whiteboards 2a, 2b, and 2c is established, and then the stroke data that is generated by any one of the electronic whiteboards 2a, 2b, and 2c is accumulated in the page data memories 220 of the electronic whiteboards 2a, 2b, and 2c.

<Establishment of Communication Between Electronic Whiteboard and Transmission Terminal>

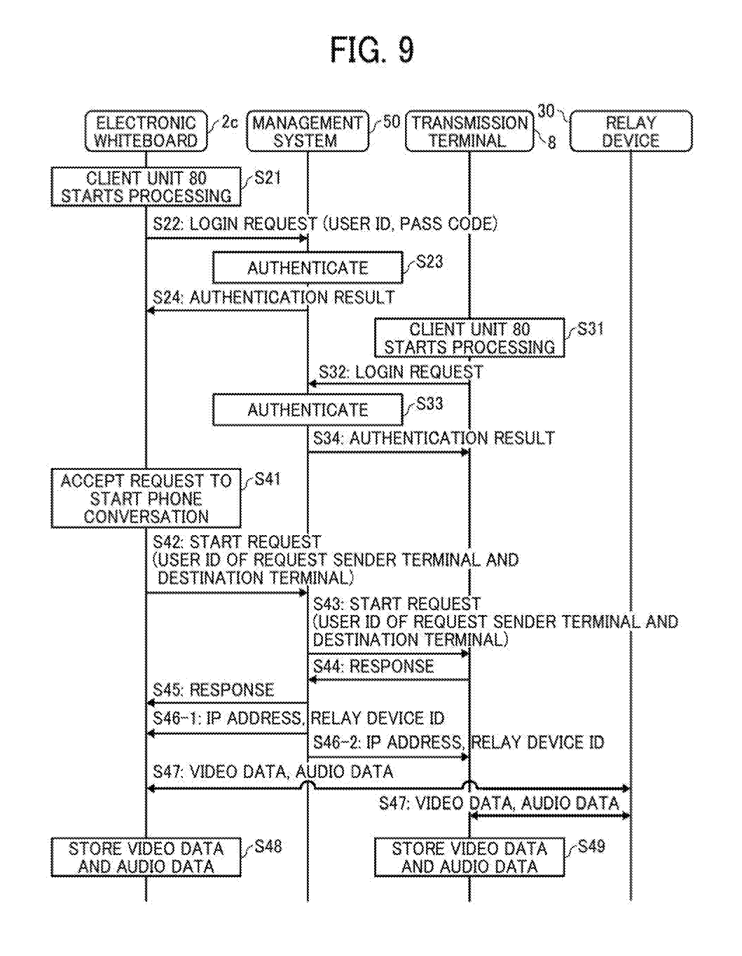

With reference to FIG. 9, the processes of establishing communication between the electronic whiteboard 2c and the transmission terminal 8, using the communication application B11, are described.

FIG. 9 is a sequence diagram illustrating the processes of establishing communication between the electronic whiteboard 2c and the transmission terminal 8, according to the present embodiment.

As the communication application B11 is started in the electronic whiteboard 2c in response to a user's operation, the client unit 80 starts various kinds of processing (step S21).

The communication controller 81 of the client unit 80 sends a login request to the management system 50 (step S22). This login request includes a user ID and a pass code. Accordingly, the communication controller 51 of the management system 50 receives the login request.

The management system 50 authenticates the electronic whiteboard 2c that has sent the login request (step S23), based on whether a pair of user ID and a pass code included in the login request matches a pair of user ID and a pass code stored in the memory 5000 in advance. The communication controller 51 of the management system 50 sends an authentication result to the electronic whiteboard 2c that has sent the login request (step S24). Accordingly, the communication controller 81 of the electronic whiteboard 2c receives the authentication result. In the following description, cases in which the electronic whiteboard 2c is determined to be an authorized login request sender are described.

Once a request to start the communication application B11 is accepted by user's operation made on the transmission terminal 8, the communication application B11 starts operating, and the client unit 80 of the transmission terminal 8 starts various kinds of processing (step S31).

The communication controller 81 of the transmission terminal 8 sends a login request including the user ID and pass code to the management system 50 (step S32). Then, the management system 50 receives this login request.

The management system 50 authenticates the transmission terminal 8 that has sent the login request using the user ID and the pass code included in the login request (step S33), and sends the authentication result to the transmission terminal 8 (step S34). In the following description, cases in which the transmission terminal 8 is determined to be an authorized login request sender are described.

In response to operation made by a user of the electronic whiteboard 2c, the input acceptance unit 83 of the electronic whiteboard 2c accepts a request to start a phone conversation with the transmission terminal 8 (step S41). In response to the acceptance of the request to start a phone conversation, the communication controller 81 of the electronic whiteboard 2c sends a request to start a phone conversation to the management system 50 (step S42). This request to start a phone conversation includes the user ID of the electronic whiteboard 2c that is the request sender terminal and the user ID of the transmission terminal 8 that is the destination terminal.

When the request to start a phone conversation sent from the electronic whiteboard 2c is received, the communication controller 51 of the management system 50 sends the received request to start a phone conversation to the transmission terminal 8 that is the counterpart terminal (step S43).

The communication controller 81 of the transmission terminal 8 receives the request to start a phone conversation sent from the management system 50. Once a user of the transmission terminal 8 operates the transmission terminal 8 to accept the request to start a phone conversation, the communication controller 81 sends acceptance data to the management system 50 (step S44).

Once the communication controller 51 of the management system 50 receives the acceptance data sent from the transmission terminal 8, the communication controller 51 sends the acceptance data to the electronic whiteboard 2c that has sent the start request (step S45). The communication controller 81 of the electronic whiteboard 2c receives the acceptance data sent from the management system 50.

Then, the management system 50 establishes communication between the electronic whiteboard 2c and the transmission terminal 8 (steps S46-1 and S46-2). In these processes, the communication controller 51 of the management system 50 sends the IP address of the electronic whiteboard 2c or the transmission terminal 8 that serves as the counterpart communication terminal, and the relay device ID of the relay device 30, to the transmission terminal 8 and the electronic whiteboard 2c. The communication controller 81 of each of the transmission terminal 8 and the electronic whiteboard 2c sends the relay device ID and the IP address received from the management system 50 to the relay device 30, and establishes a connection with the relay device 30.

The communication controller 81 of each of the transmission terminal 8 and the electronic whiteboard 2c sends the video data of the video recorded by the camera 207 or the camera 812 on the local terminal side and the audio data of the sound recorded by the microphone 222 or the microphone 814 on the local communication terminal side to the relay device 30. The relay device 30 relays the image data and audio data between the transmission terminal 8 and the electronic whiteboard 2c (step S47). The communication controller 81 of each of the transmission terminal 8 and the electronic whiteboard 2c receives the video data and audio data on the counterpart communication terminal side. Note that the above video data and audio data is streaming data and includes a plurality of pieces of image data or audio data that are divided by time.

Once the communication controller 81 of the electronic whiteboard 2c newly receives the image data and audio data, updates the image data and audio data stored in the memory 2000 to the newly received image data and audio data (steps S48 and S49). Due to this configuration, the latest image data and audio data are stored in the memory 2000.

<Generation of Image by Communication Application A11>

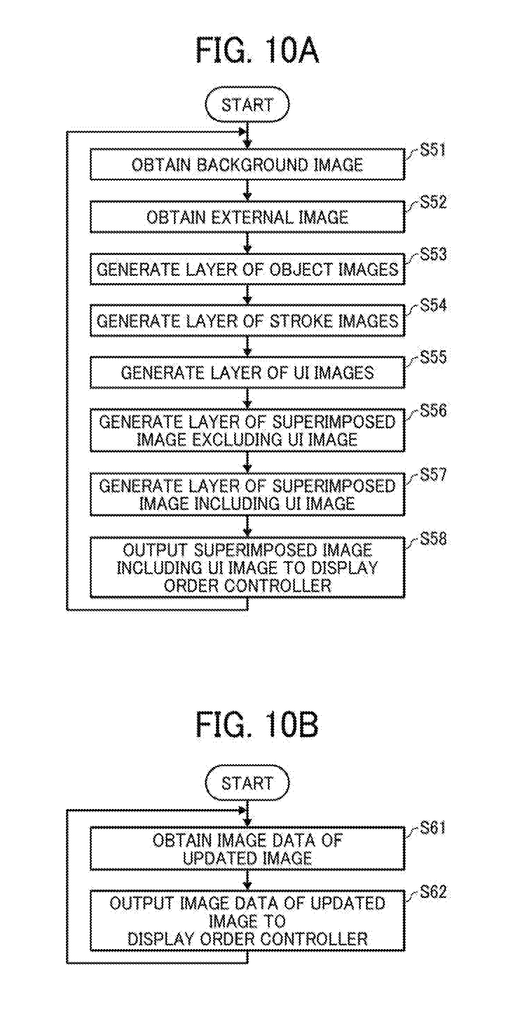

Next, the processes of generating an image based on the stroke data are described with reference to FIG. 10A.

FIG. 10A is a flowchart of the processes of generating an image using the communication application A11, according to the present embodiment.

In the following description, the processes of generating an image using the communication application A11 of the electronic whiteboard 2c are described.

The image data of a background image is stored in the page data memory 220. The page processor 22Z of the electronic whiteboard 2c obtains the image data of a background image stored on the page data memory 220 (step S51). The background image has a nontransparent area of the resolution (size) of the screen of the display 3, and is, for example, a white and plain image. The background image is used as a layer of the background image that makes up the screen in the later processes as will be described later.

Once the laptop PC 6 is connected to the electronic whiteboard 2c, the same image as the one to be output to the display of the laptop PC 6c to the electronic whiteboard 2c. The page processor 22Z of the electronic whiteboard 2c obtains an external image input from the laptop PC 6c (step S52). The external image is used as a layer of the external image that makes up the screen in the later processes as will be described later. When no external image is input, the page processor 22Z of the electronic whiteboard 2c skips the processes in the step S52.

The image data (medium data) of object images is stored in the page data memory 220. The object images are, for example, images of a predetermined object such as a circle, rectangular, and a triangle. The page processor 22Z of the electronic whiteboard 2c generates a layer of object images where specified ones of the object images stored in the page data memory 220 are arranged at positions specified by the user's operation (step S53). In these processes, the page processor 22Z superimposes object images on the transparent pixel area of the resolution (size) of the screen of the display 3.

The page processor 22Z of the electronic whiteboard 2c generates a layer of stroke images based on the stroke data accumulated in the page data memory 220 (see the step S15) (step S54). In these processes, the page processor 22Z superimposes the stroke images indicated by the stroke data on the transparent pixel area of the resolution (size) of the screen of the display 3. For example,

When stroke data indicating the text of “S” in black is stored in the page data memory 220, the page processor 22Z generates a layer of stroke images including the text “S” in black thereon.

The page data memory 220 of the electronic whiteboard 2c stores the image data of a user interface (UI) image. Such image data of a UI image is, for example, an icon or key related to the drawing operation. The page processor 22Z of the electronic whiteboard 2c generates a layer of UI images based on the image data of a UI image stored in the page data memory 220 (step S55). In these processes, the page processor 22Z superimposes the U images indicated by the image data of the UI images on the transparent pixel area of the resolution (size) of the screen of the display 3.

The superimposition unit 22Y of the electronic whiteboard 2c performs rendering and sequentially superimposes the layer of a background image obtained in the step S51, the layer of an external image obtained in the step S52, the layer of object images generated in the step S53, and the layer of stroke images generated in the step S54 on top of one another to generate a layer of a superimposed image excluding the UI image (step S56). When a layer of an external image is not obtained in the step S52, i.e., when the laptop PC 6 is not connected to the electronic whiteboard 2c, the superimposition unit 22Y generates the layer of a superimposed image excluding the layer of an external image and the UI image.

Further, the superimposition unit 22Y of the electronic whiteboard 2c performs rendering and sequentially superimposes the layer of a superimposed image, excluding the UI image, generated in the step S56, the layer of a background image obtained in the step S51, the layer of an external image obtained in the step S52, the layer of object images generated in the step S53, the layer of stroke images generated in the step S54, and the layer of UI images generated in the step S55 on top of one another to generate a layer of a superimposed image including the UI images (step S57). When a layer of an external image is not obtained in the step S52, i.e., when the laptop PC 6 is not connected to the electronic whiteboard 2c, the superimposition unit 22Y generates the layer of a superimposed image excluding the layer of an external image but including the UI image.

The superimposition unit 22Y of the electronic whiteboard 2c outputs a layer of a superimposed image including the UI image to the display order controller 24 (step S58).

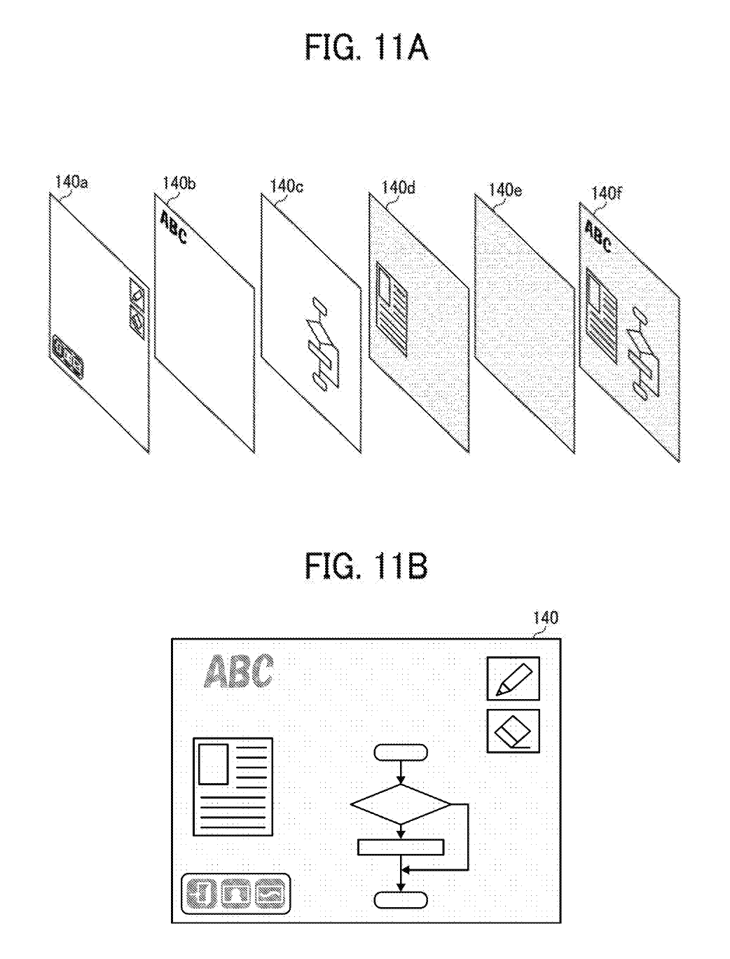

FIG. 11A is a diagram illustrating multiple layers of a superimposed image including a UI image, according to the present embodiment.

FIG. 11B is a diagram illustrating a superimposed image including a UI image, according to the present embodiment.

As illustrated in FIG. 11A and FIG. 11B, the superimposed image 140 including the UI images includes a layer 140a of the UI images, a layer 140b of the stroke images, a layer 140c of the object images, a layer 140d of the external image, a layer 140e of the background image, and a layer 140f of the superimposed image excluding the UI image. As the layer 140e of the background image is a full screen and nontransparent, the layer 140f of the superimposed image excluding the UI image is invisible on the superimposed image 140.

While the communication application A11 is operating, the client unit 20 of the electronic whiteboard 2c repeats the processes in the steps S51 to S58. Due to this configuration, a superimposed image that is updated with the latest background image, external image, object image, stroke image, and the UI image is repeatedly output to the display order controller 24.

<Generation of Image by Communication Application B11>

Next, the processes of generating an image based on the video data exchanged between the electronic whiteboard 2c and the transmission terminal 8 are described with reference to FIG. 10B.

FIG. 10B is a flowchart of the processes of generating an image using the communication application B11, according to the present embodiment.

In the following description, the processes of generating an image using the communication application B11 of the electronic whiteboard 2c are described.

The display controller 82 of the electronic whiteboard 2 obtains the image data of an updated image stored in the memory 2000 (see step S48) (step S61). Note that the image data of an updated image indicates the image data of the latest image in the video data received by the electronic whiteboard 2c.

The display controller 82 of the electronic whiteboard 2 outputs the image data of an updated image obtained in the step S61 to the display order controller 24 (step S62).

While the communication application B11 is operating, the client unit 80 of the electronic whiteboard 2c repeats the processes in the steps S61 and S62. Accordingly, the latest images that together configure a video are repeatedly output to the display order controller 24.

The display order controller 24 of the electronic whiteboard 2c controls the images output from the client unit 20 and the images output from the client unit 80, according to operation made by a user or events caused due to the communication performed by the communication applications A11 or B11, such that the images output from the client unit 20 are activated and the images output from the client unit 80 are deactivated or such that the images output from the client unit 20 are deactivated and the images output from the client unit 80 are activated. In these processes, the display order controller 24 controls the images output from the client unit 20 and the images output from the client unit 80 such that the images output from the client unit 20 are displayed in the foreground of the screen of the display 3c or such that the images output from the client unit 80 are displayed in the foreground of the screen of the display 3c. Due to this configuration, one of the superimposed image output in the step S58 and the video of a video conference output in the step S62 is actively output from the display 3c of the electronic whiteboard 2c.

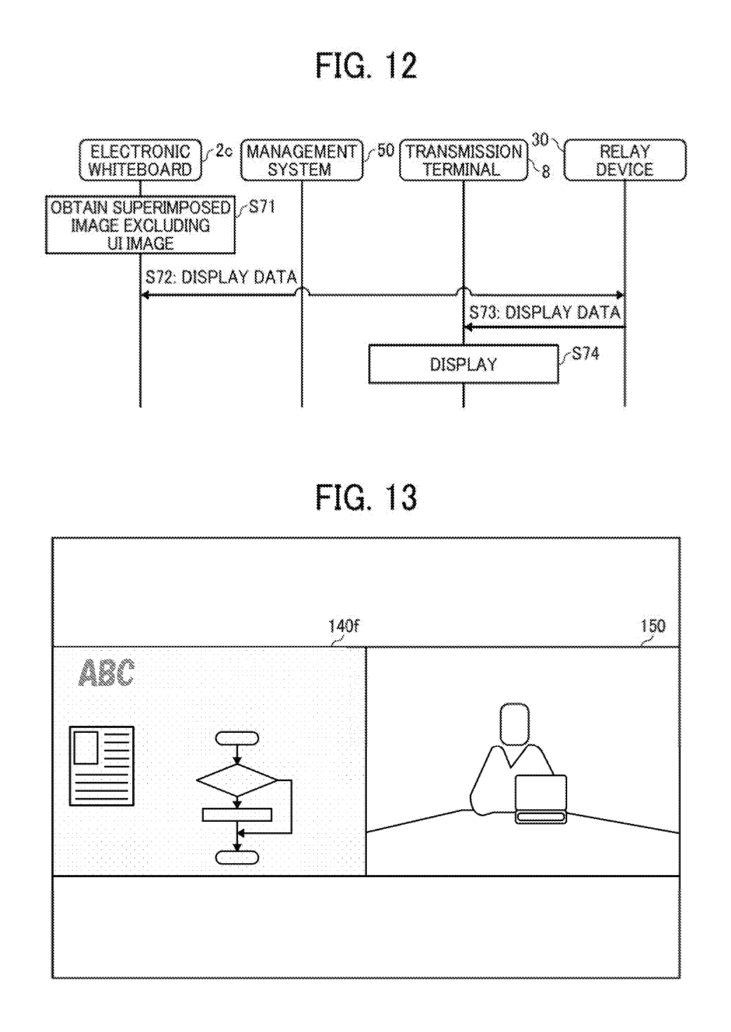

Next, the processes of sending the screen image of the display 3c of the electronic whiteboard 2c to the transmission terminal 8 are described with reference to FIG. 12.

FIG. 12 is a sequence diagram illustrating the processes of sending the screen image on the electronic whiteboard 2c side to the transmission terminal 8, according to the present embodiment.

The electronic whiteboard 2c accepts a request to share the screen of the display 3c with the transmission terminal 8. Such a request may be made by operation or input by a user of the electronic whiteboard 2c, or may be made by the transmission terminal 8. Once such a request is accepted, the communication controller 81 of the electronic whiteboard 2c obtains the layer of a superimposed image excluding the UI image, which is generated in the step S56 (step S71).

The communication controller 81 of the electronic whiteboard 2c sends the obtained layer of a superimposed image, excluding the UI image, to the relay device 30 as the display data indicating the screen that is being displayed on the electronic whiteboard 2c side (step S72).

Once the display data sent from the electronic whiteboard 2c is received, the relay device 30 sends the received display data to the transmission terminal 8 (step S73). When scalable communication is established between the relay device 30 and one of the electronic whiteboard 2c and the transmission terminal 8, the display data that is received from the electronic whiteboard 2c may be sent to the transmission terminal 8 upon its quality being changed according to, for example, the bandwidth of the communication network 9b.

The communication controller 81 of the transmission terminal 8 receives the display data sent from the relay device 30. The display controller 82 of the transmission terminal 8 sends the video data on the electronic whiteboard 2c side sent from the relay device 30 in the step S47 and the display data of the screen that is being displayed on the electronic whiteboard 2c sent from the relay device 30 in the step S73 to the display 820 of the transmission terminal 8 (step S74).

FIG. 13 is a diagram illustrating an example image displayed on the display 820 on the transmission terminal 8 side in the step S74, according to the present embodiment.

As illustrated in FIG. 13, a video 150 of a conference participant on the electronic whiteboard 2c side and the layer 140f of a superimposed image, excluding the UI image, as a display screen, are displayed on the display 3.

Every time the layer of a superimposed image, excluding the UI image, is generated in the step S56, the communication controller 81 of the electronic whiteboard 2c sends the display data newly obtained in the step S71 to the relay device 30. Accordingly, the transmission terminal 8 receives the updated display data and outputs the received display data to the display 820.

### Second Embodiment

Next, a second embodiment of the present disclosure is described. In particular, differences in configuration from the embodiment as described above are described.

In the processes in the step S53, the page processor 22Z of the electronic whiteboard 2c superimposes an input external image on the nontransparent pixel area of the resolution (size) of the screen of the display 3 to generate a layer of the external image. Due to these processes, a full screen and nontransparent layer of the external image is generated.

When an external image is input from the laptop PC 6c and a full screen and nontransparent layer of the external image is generated in the step S53, in the step S56, the superimposition unit 22Y of the electronic whiteboard 2c generates a superimposed image, excluding the UI images, where a layer of object images and a layer of stroke images are superimposed on the layer of the external image in that order. As a layer of the external image is a full screen and nontransparent, even if the background image is not included in the images to be superimposed, the same superimposed image as the one generated when the background image is included in the images to be superimposed is generated. Due to this configuration, a layer of the background image is excluded from the images to be superimposed, and the load of processes on the superimposition unit 22Y can be reduced.

### Third Embodiment

Next, a third embodiment of the present disclosure is described. In particular, differences in configuration from the embodiments as described above are described.

The page data memory 220 of the electronic whiteboard 2c stores a functional configuration screen and a videoconference configuration screen. When activated or according to a request made by a user, the page processor 22Z of the electronic whiteboard 2c obtains the functional configuration screen stored in the page data memory 220, as a layer of UI images the superimposition unit 22Y outputs a superimposed image that includes the obtained functional configuration screen to the display order controller 24. The display order controller 24 outputs the image data including the functional configuration screen to the display 3c.

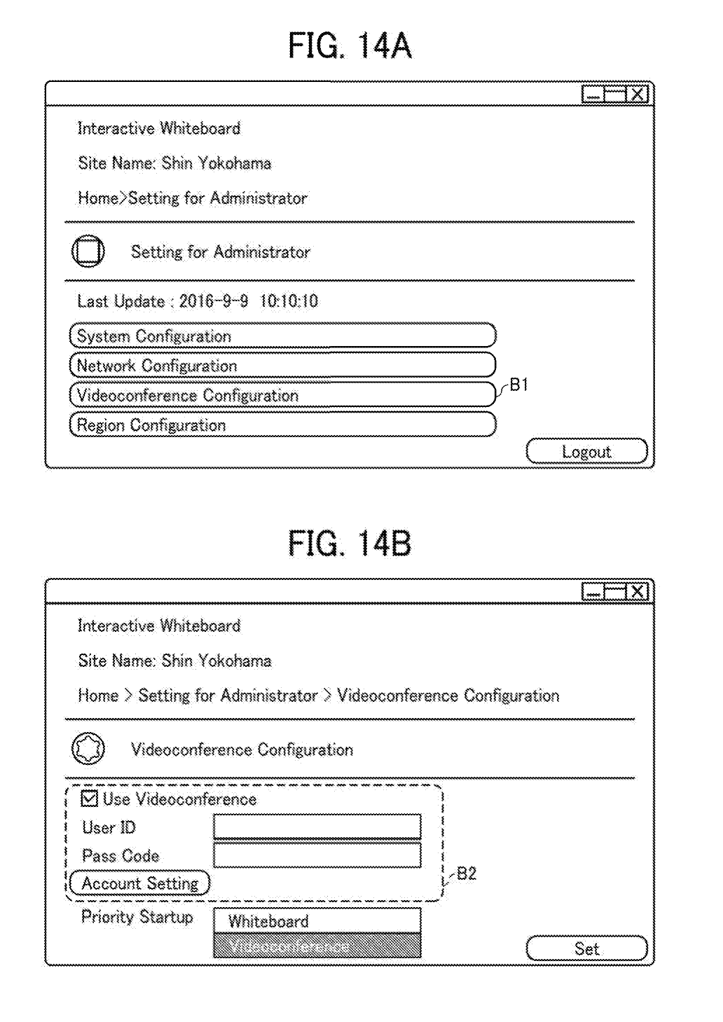

FIG. 14A is a diagram illustrating a functional configuration screen, according to the present embodiment.

The functional configuration screen includes a key B1 thereon for shifting to a videoconference configuration screen.

When a user touches the key B1 being output to the display 3c, using the electronic stylus 4c or the like, the page processor 22Z of the electronic whiteboard 2c obtains the videoconference configuration screen stored in the page data memory 220. In the step S57, the superimposition unit 22Y outputs a superimposed image that includes the obtained videoconference configuration screen to the display order controller 24. The display order controller 24 outputs the image data including the videoconference configuration screen to the display 3c.

FIG. 14B is a diagram illustrating a videoconference configuration screen, according to the present embodiment.

When a user ticks a checkbox for using the video conference function within an input field B2 on the videoconference configuration screen, using the electronic stylus 4c or the like, the communication application B11 stores in the memory 2000 the data indicating that the management system 50 is to be used for a video conference.

In the processes of the step S56, the superimposition unit 22Y of the electronic whiteboard 2c refers to the memory 2000 and determines whether the data indicating that the management system 50 is to be used is stored therein. Here, when it is determined that the data indicating that the management system 50 is to be used is stored, the superimposition unit 22Y generates a superimposed image excluding the UI images. On the other hand, when it is determined that the data indicating that the management system 50 is to be used is not stored, the superimposition unit 22Y does not generate a superimposed image excluding the UI images. Due to the determination made as above, when it is assumed that the screen sharing function by the communication application B11 is not to be used, the processes of generating a superimposed image excluding the UI images can be omitted in the electronic whiteboard 2c. Accordingly, the load of processes can be reduced.

Alternatively, a communication terminal such as a PC may be connected to the communication network 9a or 9b, and such a communication terminal may be allowed to access a desired electronic whiteboard 2 by inputting the IP address of the desired electronic whiteboard 2 through a Web browser. Due to this configuration, a videoconference configuration screen of the electronic whiteboard 2 may be displayed on the communication terminal such as a PC, and the above items become configurable.

### Fourth Embodiment

Next, a fourth embodiment of the present disclosure is described. In particular, differences in configuration from the embodiments as described above are described.

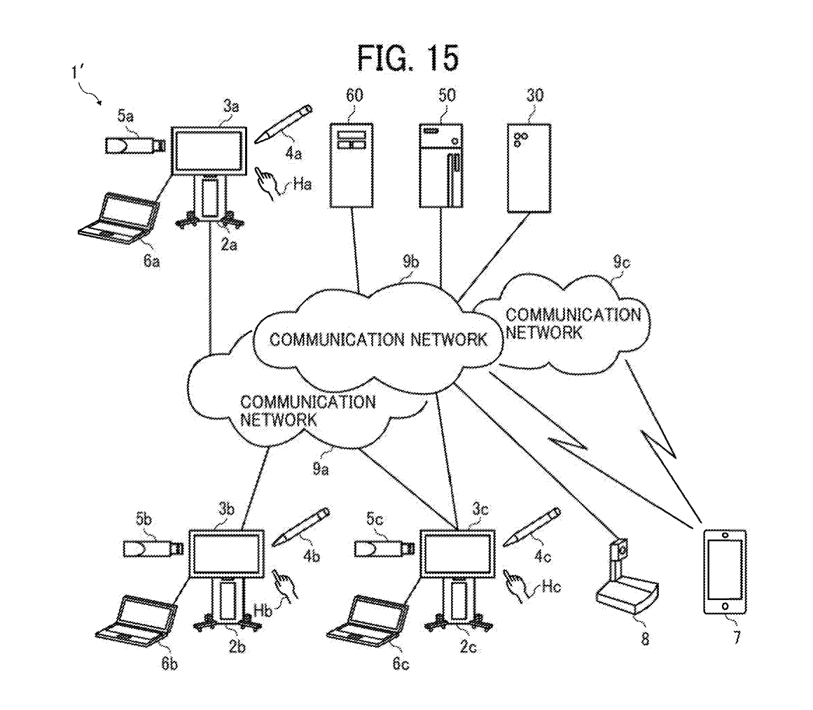

FIG. 15 is a diagram illustrating a schematic configuration of a communication system 1′, according to a fourth embodiment of the present disclosure.

As illustrated in FIG. 15, the communication system 1′ further includes a data server 60 and a telephone terminal 7 in addition to the devices and apparatuses in the communication system 1.

The communication system 1′ includes a communication network 9c that serves as a mobile phone network. The communication network 9c is connected to the communication network 9b, i.e., the Internet, through a gateway. At the end of the communication network 9c, a base station is installed. At the end of the communication network 9b, a wireless LAN router that serves as the access point of radio communication is installed.

The telephone terminal 7 is, for example, a mobile communication device such as a smartphone, and is connected to the communication network 9c through a base station to communicate with another telephone terminal 7. Further, the telephone terminal 7 communicates with the data server 60 and the electronic whiteboard 2 by connecting to the communication network 9b through a wireless LAN router or by connecting to the communication network 9b through a base station, the communication network 9c, and a gateway.

The data server 60 is connected to the communication network 9b. The data server 60 stores the data uploaded from any client communication device. Moreover, the data server 60 accepts a request to download data from any client communication device.

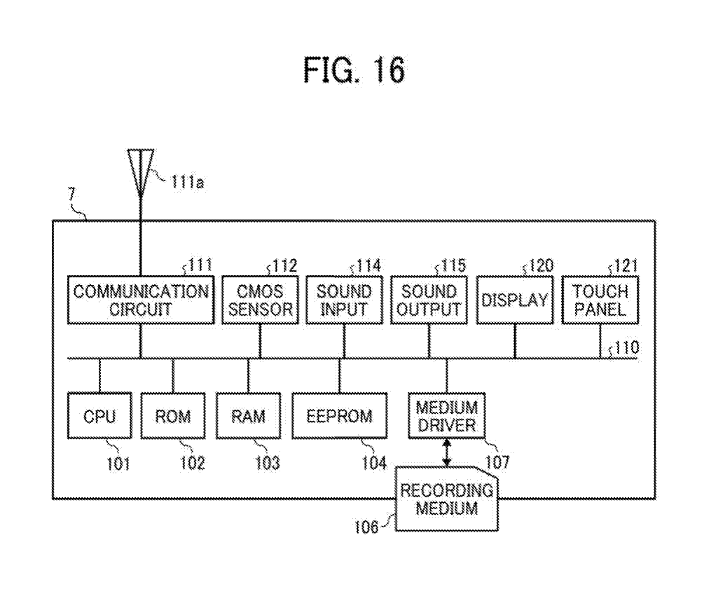

FIG. 16 is a schematic block diagram illustrating a hardware configuration of a telephone terminal 7, according to the present embodiment.

As illustrated in FIG. 16, the telephone terminal 7 is provided with a central processing unit (CPU) 101 that controls the overall operation of the telephone terminal 7, a read-only memory (ROM) 102 storing a program, a random access memory (RAM) 103 that is used as a work area in which the CPU 101 executes a program, an electrically erasable and programmable read only memory (EEPROM) 104 that controls reading or writing of various kinds of data under control of the CPU 101, and a medium drive 107 that controls reading or writing of data to or from a recording medium 106 such as a flash memory. Note that the recording medium 106 is removable from the medium drive 107, and data recorded in the recording medium 106 is read therefrom or data is newly written and stored on the recording medium 106 under control of the medium drive 107. Note also that the EEPROM 104 stores an operating system (OS) to be executed by the CPU 101, other various kinds of programs, and various types of data.

Further, the telephone terminal 7 is provided with an antenna 111a, and a communication circuit 111 that uses the antenna 111a and radio communication signals to communicate with a nearest base station. Further, the telephone terminal 7 is provided with a complementary metal oxide semiconductor (CMOS) sensor 112 that captures an object under the control of the CPU 101 to obtain captured-image data, a sound input 114 that converts the sound into an audio signal, and a sound output 115 that converts the audio signal into sound. Note also that the CMOS sensor 112 may be a charge coupled device that converts an image of an object into electronic data through photoelectric conversion. In other words, as long as it can capture an object, the CMOS sensor may be replaced with a charge coupled device (CCD) sensor. Moreover, the sound input 114 includes a microphone for receiving sound, and the sound output 115 includes a loudspeaker to output sound. Further, the telephone terminal 7 is provided with a display 120 such as a liquid crystal display (LCD) or an organic electroluminescence (EL) display that display an image of an object, various kinds of icons, or the like, and a touch panel 121 that is made of a pressure-sensing or electrostatic panel and disposed on the display 120. The touch panel 121 detects a touch point on the display 120 by a finger, an electronic stylus, or the like. Further, the telephone terminal 7 is provided with a bus line 110 such as an address bus or a data bus that electrically connects the elements as illustrated in FIG. 16.

The hardware configuration of the data server 60 is equivalent to the hardware configuration of the management system 50, and thus its description is omitted.

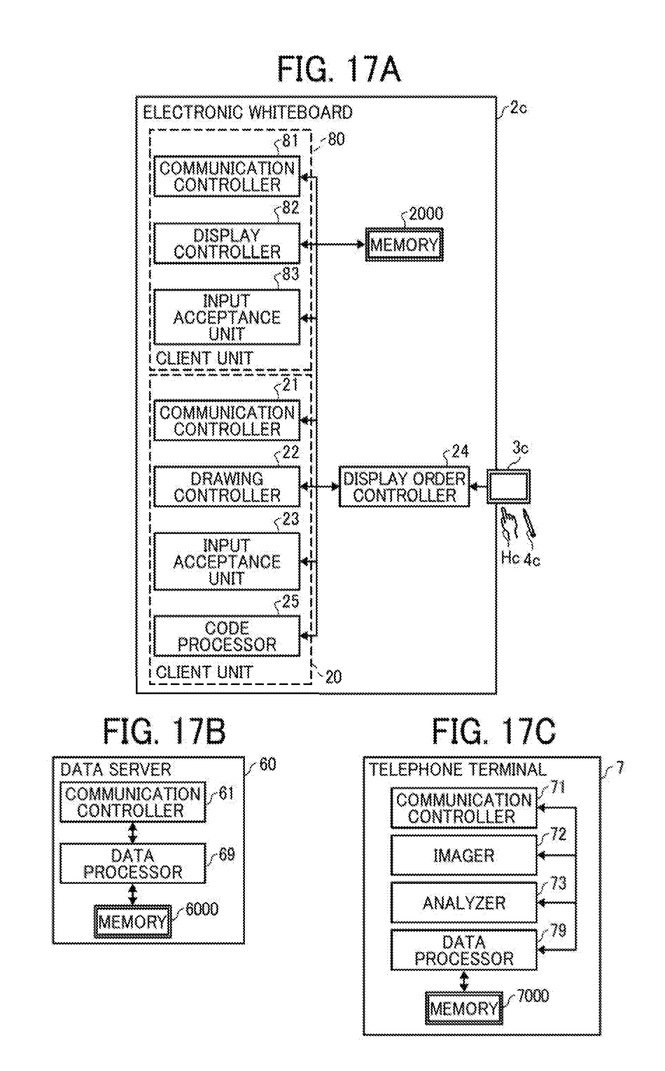

FIG. 17A is a functional block diagram of the electronic whiteboard 2c, according to the fourth embodiment.

In addition to the functional configuration according to the embodiments described above, the client unit 20 of the electronic whiteboard 2c according to the fourth embodiment includes an input acceptance unit 23 and a code processor 25.

The input acceptance unit 23 receives various kinds of operation or input made by a user according to the instructions from the CPU 201, or operation of the sensor controller 214 and the contact sensor 215.

The code processor 25 generate a bar code used to download data according to operation or input made by a user. Such a bar code used to download data will be described later in detail.

FIG. 17B is a functional block diagram of the data server 60, according to the fourth embodiment.

The data server 60 includes a communication controller 61 and a data processor 69. Moreover, the data server 60 includes a memory 6000 that is configured by the HD 504 illustrated in FIG. 3.

The memory 6000 stores various kinds of data uploaded from any client communication device. Such various kinds of data includes, for example, image data such as of Joint Photographic Experts Group (JPEG), tagged image file fbrmat (TIFF), portable network graphics (PNG), or bitmap (BMP), video data such as of Moving Picture Experts Group (MPEG)-4, a computer aided design (CAD) file, a text, or a file used by a word processing program, a spreadsheet program, a presentation program, or a viewer.

The communication controller 61 may be implemented by the instructions from the CPU 201 and the network interface 205, and controls communication performed with the electronic whiteboard 2 or the telephone terminal 7.

The data processor 69 may be implemented by the instructions from the CPU 201 and the HDD 505, and controls the memory 6000 to store various kinds of data or reads various kinds of data from the memory 6000.

FIG. 17C is a functional block diagram of the telephone terminal 7, according to the fourth embodiment.

The telephone terminal 7 includes a communication controller 71, an imager 72, an analyzer 73, and a data processor 79. Moreover, the telephone terminal 7 includes the ROM 102, the RAM 103, the EEPROM 104, or the memory 7000 implemented by the recording medium 108.

The communication controller 61 may be implemented by the instructions from the CPU 101 and the communication circuit 11l, and controls communication performed with the electronic whiteboard 2 or the data server 60.

The imager 72 may be implemented by the CMOS sensor 112, and captures any desired object such as a bar code displayed on the display 3c of the electronic whiteboard 2c.

The analyzer 73 may be implemented by the instructions from the CPU 101, and analyzes a bar code captured by the imager 72 to extracts code data from the bar code. Such code data extracted from a bar code will be described later.

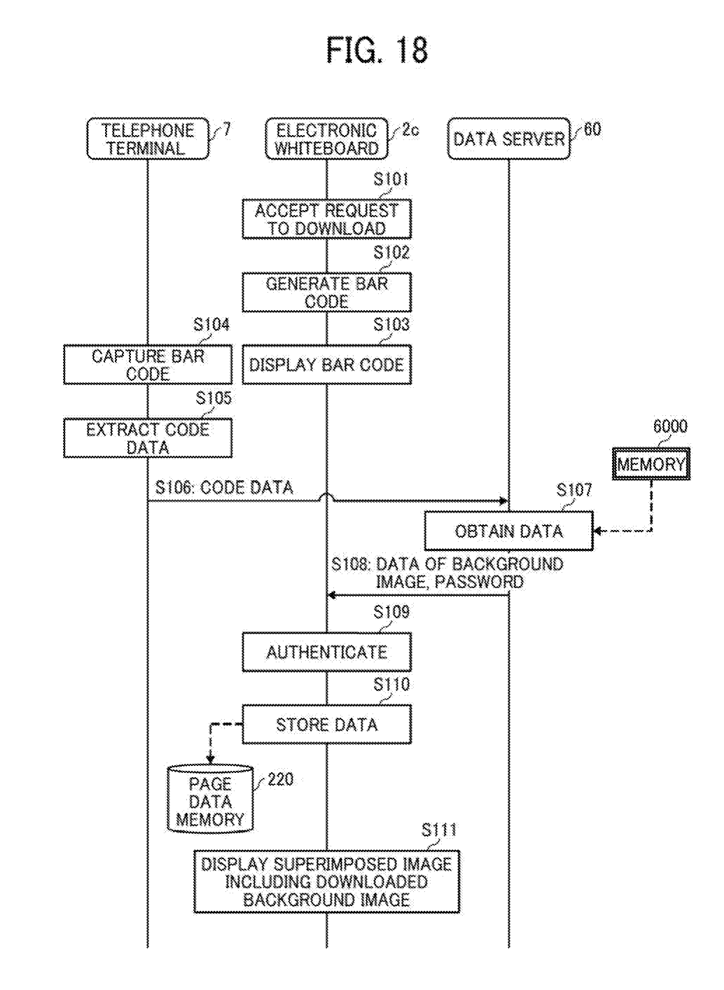

FIG. 18 is a sequence diagram illustrating the processes of downloading the data of a background image by the electronic whiteboard 2c, according to the fourth embodiment of the present disclosure.

With reference to FIG. 18, how the electronic whiteboard 2c downloads the data of a background image is described.

In response to operation or input made by a user of the electronic whiteboard 2c to download the background image of the display 3c, the input acceptance unit 23 of the electronic whiteboard 2c accepts a request to download a background image (step S101). Hereinafter, a request to download a background image will be referred to simply as a downloading request.

Once input of a downloading request is accepted by the electronic whiteboard 2c, the code processor 25 generates a bar code to be used to download a background image (step S102). In these processes, the code processor 25 generates a bar code that indicates, based on predetermined standards, code data such as identification information indicating a downloading request, identification information of a background image as the data to be downloaded, the destination address of the background image, and a password. Such predetermined standards includes, for example, Japanese Article Number (JAN), European Article Number (EAN), Universal Product Code (UPC), Interleaved Two of Five (ITF), CODE 39, CODE 128, and NW-7. The identification information of a background image is, for example, a file name, and the destination address to which the image data is to be sent is, for example, a uniform resource locator (URL) that indicates the electronic whiteboard 2c Moreover, the password is, for example, prescribed in advance by the electronic whiteboard 2c. A part of or the entirety of the code data may be input by a user of the electronic whiteboard 2c.

In the step S55, the page processor 22Z of the electronic whiteboard 2c generates a layer of UI images including the UI images stored in the page data memory 220 and the bar code generated in the step S102. In the step S58, the superimposition unit 22Y of the electronic whiteboard 2c outputs a superimposed image including the layer of UI images and the bar code to the display order controller 24. The display order controller 24 controls the display 3c to display the superimposed image including the layer of UI images and the bar code (step S103).

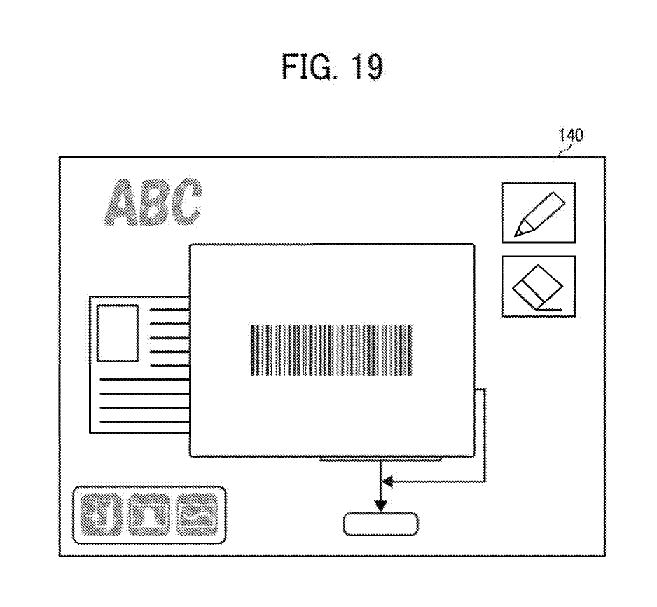

FIG. 19 is a diagram illustrating an example image on the display in the step S103, according to the present embodiment.

The imager 72 of the telephone terminal 7 captures a bar code displayed on the display 3c of the electronic whiteboard 2c according to operation made by a user (step S104) The analyzer 73 of the telephone terminal 7 analyzes the captured bar code. More specifically, in accordance with the prescribed rules, the analyzer 73 extracts, from the bar code included in the captured image, code data such as identification information indicating a downloading request, identification information of a background image, the destination address of the background image, and a password (step S105). Note also that the password out of the extracted code data is used later in the processes of authentication. For this reason, the password is displayed on the display 120 in accordance with the instructions given from the CPU 101. In an alternative embodiment of the present disclosure, a password is not included in the code data, and thus such a password does not need to be displayed on the electronic whiteboard 2c. In such a configuration, a password may be input, for example, by a user of the telephone terminal 7, or may be stored in the memory 7000 of the telephone terminal 7 as setting data of an application. The communication controller 71 of the telephone terminal 7 sends the extracted code data to the data server 60 (step S106). In an alternative embodiment of the present disclosure, the password input by a user or the password stored in the memory 7000 is sent to the data server 60.

The communication controller 61 of the data server 60 receives the code data sent from the telephone terminal 7. The data processor 69 of the data server 60 obtains the data of a background image identified by the identification information included in the code data from the memory 6000 (step S107). The communication controller 61 of the data server 60 sends the obtained data of the background image and the password included in the code data to the electronic whiteboard 2c that is identified by the destination address included in the code data (step S108).

The communication controller 21 of the electronic whiteboard 2c receives the data of the background image sent from the data server 60. In other words, the electronic whiteboard 2c downloads the data of a background image from the data server 60. Once the electronic whiteboard 2c downloads the data of a background image, the input acceptance unit 23 accepts the input of a password. The code processor 25 of the electronic whiteboard 2c determines whether the password received by the input acceptance unit 23 matches the password included in the code data generated in the step S102. When these passwords match one another, the code processor 25 authenticates the user (step S109). Once the user is authenticated, the page processor 22Z of the electronic whiteboard 2c stores the downloaded data of a background image in the page data memory 220 (step S110).

After the downloaded data of a background image is stored on the page data memory 220, the page processor 22Z of the electronic whiteboard 2c obtains the downloaded data of a background image from the page data memory 220 in the step S51. Once the page processor 22Z obtains the downloaded data of a background image, in the steps S57 and S58, the superimposition unit 22Y of the electronic whiteboard 2c performs rendering and generates a superimposed image including the downloaded data of a background image, and outputs the generated superimposed image to the display order controller 24. Once the superimposition unit 22Y outputs the superimposed image including the downloaded data of a background image, the display order controller 24 of the electronic whiteboard 2c controls the display 3c to display a superimposed image including the downloaded data of a background image (step S111).

Once the page processor 22Z obtains the downloaded data of a background image, in the step S56, the superimposition unit 22Y of the electronic whiteboard 2c performs rendering and generates a superimposed image including the downloaded data of a background image but excluding the UI images. Once the superimposition unit 22Y generates the superimposed image including the downloaded data of a background image but excluding the UI images, in the step S71, the communication controller 81 of the electronic whiteboard 2c obtains the superimposed image including the downloaded data of a background image but excluding the UI images.

In the step S72, the communication controller 81 of the electronic whiteboard 2c sends the superimposed image including the downloaded data of a background image but excluding the UI images to the relay device 30 as display data.

Subsequently, in a similar manner to the processes in the steps S73 and S74 of the embodiments as described above, the relay device 30 relays the display data sent from the electronic whiteboard 2c to the transmission terminal 8, and the transmission terminal 8 receives the display data sent from the relay device 30 and controls the display 820 to display an image. Note that as the display data does not include the UI images, the bar code that is displayed on the electronic whiteboard 2c side as a UI image is not displayed on the transmission terminal 8 side.

### Fifth Embodiment

Next, a fifth embodiment of the present disclosure is described. In particular, differences in configuration from the fourth embodiment as described above are described.

In the fifth embodiment, the data server 60 in the communication system 1′ according to the fourth embodiment may be omitted. In the fifth embodiment, the memory 7000 of the telephone terminal 7 stores various kinds of data uploaded from any client communication device. Such various kinds of data is equivalent to the data that the data server 60 according to the fourth embodiment stores in the memory 6000.

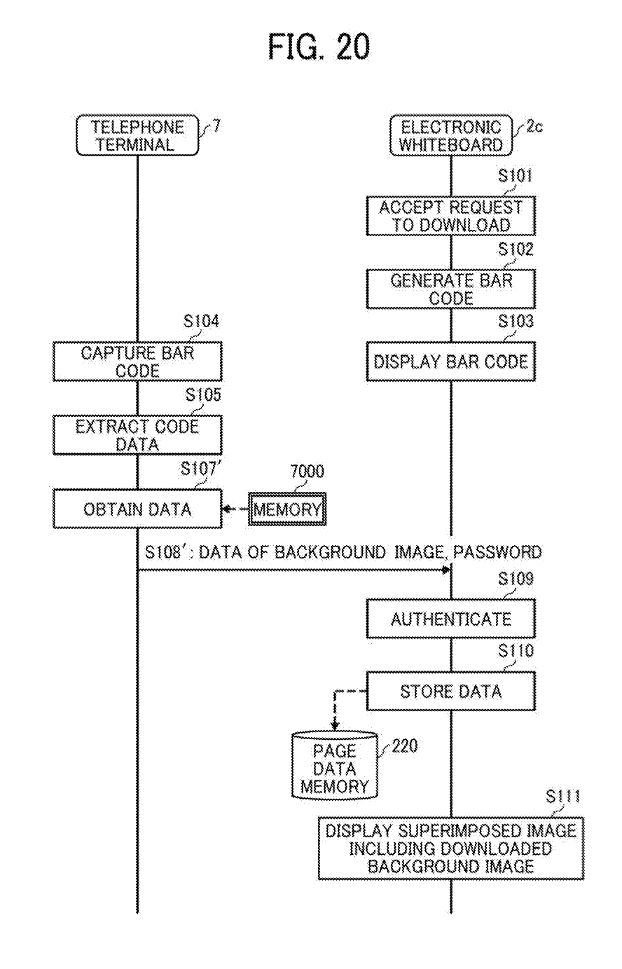

FIG. 20 is a sequence diagram illustrating the processes of downloading the data of a background image by the electronic whiteboard 2c, according to the fifth embodiment of the present disclosure.

With reference to FIG. 20, differences in how the electronic whiteboard 2c downloads the data of a background image compared with that of the fourth embodiment is described.

Once the code data is extracted by the analyzer 73 of the telephone terminal 7, the data processor 79 obtains the data of a background image identified by the identification information of the background image included in the code data from the memory 7000 (step S107′) The communication controller 71 of the telephone terminal 7 sends the data of the background image and the password included in the code data to the electronic whiteboard 2c that is identified by the destination address included in the code data (step S108′).

The communication controller 21 of the electronic whiteboard 2c receives the data of the background image sent from the telephone terminal 7. In other words, the electronic whiteboard 2c downloads the data of a background image from the telephone terminal 7. The following processes are equivalent to those of the fourth embodiment, and thus their description is omitted.

With the data transmission method according to the embodiments described above, the stroke processing unit 22A of the electronic whiteboard 2c (an example of a communication terminal) accepts a drawing operation. the display order controller 24 (an example of a display controller) of the electronic whiteboard 2c controls the display 3c (an example of a display) to display on the screen of the display 3c (an example of display controlling processes) an image drawn by operation accepted by the stroke processing unit 22A and a first superimposed image where the UI images related to drawing operation are superimposed on the background image. The communication controller 81 (an example of a transmitter) of the electronic whiteboard 2c sends the display data (an example of image data) of a second superimposed image where the UI images are excluded from the images to be superimposed and the drawn images are superimposed on the background image to the transmission terminal 8 (an example of an external communication terminal) (an example of transmitting processes) as the image data to be displayed on the screen of the display. Due to this configuration, when the electronic whiteboard 2c capable of displaying the drawn images transmits its screen image to the transmission terminal 8, the UI images that cannot be manipulated via the transmission terminal 8 is no longer output to the transmission terminal 8, and reduction in viewability can be prevented. Moreover, as the electronic whiteboard 2 transmits an image where the drawn images are superimposed on the background image to the transmission terminal 8, even if the background color set on the transmission terminal 8 side is the same as the color of a drawn image, a user of the transmission terminal 8 can read the drawn image.

The superimposition unit 22Y (i.e., an example of a generator) of the electronic whiteboard 2c performs rendering and generates a layer of a second superimposed image (i.e., an example of a composite image) where a layer of drawn images are superimposed on a layer of the background image. Note that this generation of a layer of a second superimposed image is an example of a generating process. The communication controller 81 of the electronic whiteboard 2c sends the display data of the second superimposed image generated by the superimposition unit 22Y to the transmission terminal 8. Due to this configuration, the communication controller 81 can obtain the image of a screen generated by the superimposition unit 22Y and can send the obtained image to the transmission terminal 8.

The display order controller 24 of the electronic whiteboard 2c controls the display 3c to display a layer of a first superimposed image where a layer of the background image, a layer of drawn images, and a layer of UI images are superimposed on a layer of a second superimposed image in that order. In such a configuration, the layer of the second superimposed image is arranged underneath the background image. Accordingly, the electronic whiteboard 2c can make the layer of the second superimposed image invisible.

The page data memory 220 (an example of a manager) of the electronic whiteboard 2c manages the image data of the background image (an example of a first background image). The page processor 22Z (an example of an input unit) of the electronic whiteboard 2c inputs an external image (an example of a second background image) from the laptop PC 6. When the second background image is not input by the page processor 22Z, the superimposition unit 22Y of the electronic whiteboard 2c combines a layer of the background image and a layer of drawn images to generate a layer of a second superimposed image. On the other hand, when the second background image is input by the page processor 22Z, the superimposition unit 22Y of the electronic whiteboard 2c combines a layer of the external image and a layer of drawn images to generate a layer of a second superimposed image. Due to this configuration, the load of processes on the electronic whiteboard 2c in generating a layer of a second superimposed image can be reduced.

When the use of the management system 50 is not configured in the electronic whiteboard 2c, the superimposition unit 22Y of the electronic whiteboard 2c does not generate a second superimposed image. Due to this configuration, when the transmission of the display data to the transmission terminal 8 is not expected, the generation of the second superimposed image is omitted, and the load of processes on the electronic whiteboard 2c can be reduced.

A communication terminal such as a smartphone may be connected to the communication network 9a, and may transfer the file of a background image stored in the local communication terminal to any one of the electronic whiteboards 2, using, for example, a web application programming interface (API). The electronic whiteboard 2 receives the transferred file, and displays the background image in the received file as the background image of the screen. A file that is stored in a communication terminal may be a file that is generated by the scanning function of an image forming apparatus such as a multifunction peripheral (MFP) and then transferred from the image forming apparatus to the communication terminal. In such a configuration, the image forming apparatus may be connected to the communication network 9a, and may directly transfer a file generated by scanning to the communication terminal, using an email sending function of the image forming apparatus. Alternatively, the image forming apparatus may transfer a file generated by scanning to a file server connected to the communication network 9a, using a remote folder storing function of the image forming apparatus, and such transferred files may be accumulated in the file server. In this configuration, the communication terminal can store a desired file in the communication terminal by obtaining such a desired file from the files accumulated in the file server.

The communication applications A11 and B11 may be recorded on a computer-readable recording medium for distribution in an installable or executable file format. Examples of such a recording medium include, but not limited to, a compact disc-recordable (CD-R), a digital versatile disc (DVD), and a Blu-ray disc. Moreover, a memory storing any one of the above-described control programs, such as a recording medium including a CD-ROM or a HDD, may be provided in the form of a program product to users within a certain country or outside that country.

Any one of the electronic whiteboard 2, the transmission terminal 8, the relay device 30, and the management system 50 according to the embodiments described above may be implemented by a single apparatus or a plurality of apparatuses to which divided elements (functions or units) are allocated.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. The term “processing circuit” herein includes, for example, a device such as a processor that may be provided with an electronic circuit and is programmed to execute software to implement functions, an application specific integrated circuit (ASIC) that is designed to execute the above functions, and a conventional circuit module.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored on any kind of storage medium. Examples of storage media include, but are not limited to, flexible disks, hard disks, optical discs, magneto-optical discs, magnetic tape, nonvolatile memory cards, ROM, etc. Alternatively, any one of the above-described and other methods of the present invention may be implemented by ASICs, prepared by interconnecting an appropriate network of conventional component circuits, or by a combination thereof with one or more conventional general-purpose microprocessors and/or signal processors programmed accordingly.

What is claimed is:

1. A communication terminal comprising circuitry configured to control a display to display a first superimposed image where a drawn image and a user interface image related to drawing operation are superimposed on a background image, and
transmit image data of a second superimposed image, where the drawn image is superimposed on the background image and the user interface image is excluded from images to be superimposed, to an external communication terminal as image data to be displayed on the display.

2. The communication terminal according to claim 1, wherein
the circuitry performs rendering to generate a composite image of the background image and the drawn image, and
the circuitry transmits the composite image to the external communication terminal as the image data.

3. The communication terminal according to claim 2, wherein the circuitry controls the display to display the first superimposed image where the background image, the drawn image, and the user interface image are superimposed on the composite image in that order.

4. The communication terminal according to claim 2, further comprising
a memory to store a first background image,
wherein the circuitry obtains a second background image from an external device, and
wherein
when the second background image is not obtained by the circuitry, the circuitry generates a composite image of the first background image and the drawn image, as the composite image of the background image and the drawn image, and
when the second background image is obtained by the circuitry, the circuitry generates a composite image of the second background image and the drawn image, as the composite image of the background image and the drawn image.

5. The communication terminal according to claim 2, wherein when the circuitry determines that use of a management system that manages communication with the external communication terminal is not configured in the communication terminal, the circuitry does not generate the composite image.

6. A communication system comprising:
the communication terminal according to claim 1; and
the external communication terminal.

7. A communication system comprising:
the communication terminal according to claim 5;
the external communication terminal; and
the management system.

8. A method of transmitting data, the method comprising:
controlling a display to display a first superimposed image where a drawn image and a user interface image related to drawing operation are superimposed on a background image; and
transmitting image data of a second superimposed image, where the drawn image is superimposed on the background image and the user interface image is excluded from images to be superimposed, to an external communication terminal as image data to be displayed on the display.

9. A computer-readable non-transitory recording medium storing a program for causing a computer to execute a method, the method comprising:
controlling a display to display a first superimposed image where a drawn image and a user interface image related to drawing operation are superimposed on a background image; and
transmitting image data of a second superimposed image, where the drawn image is superimposed on the background image and the user interface image is excluded from images to be superimposed, to an external communication terminal as image data to be displayed on the display.
